(19) United States
(12) Patent Application Publication
(10) Pub. No.: US 2004/0044607 A1
(43) Pub. Date: Mar. 4, 2004

(54) Intermediary computing to handle debt management plan requests

(76) Inventors: Thomas W. Hedrick, JR., Marriottsville, MD (US); Michael D. Morency, Marriottsville, MD (US)

Correspondence Address: PETER K. TRZYNA, ESQ., P O BOX 7131, CHICAGO, IL, 60680, US

(21) Appl. No.: 10/654,572

(22) Filed: Sep. 2, 2003

Related U.S. Application Data
(60) Provisional application No. 60/407,737, filed on Sep. 3, 2002.

(51) Int. Cl. G06F 17/60

(52) U.S. Cl. 705/35

(57) ABSTRACT

A method for Internet-based intermediary computing to handle debt management plan requests, the method including the steps of: receiving respective debt management plan requests at an intermediary computer, by Internet communication, from each of a plurality of request-originating computers; processing the respective debt management plan requests to produce respective, formatted and at least partially validated debt management plan requests; using the respective, formatted and at least partially validated debt management plan requests in enabling a respective debt management plan decision at one of the intermediary computer and a creditor computer; and electronically communicating a signal of the decision to the request-originating computer.

### TECHNICAL FIELD OF THE INVENTION

The present invention pertains to an electrical digital computer machine and a data processing system, methods of making and for using the machine, products produced thereby, as well as data structures and articles of manufacture pertaining thereto, and all necessary intermediates of that which is discussed herein, generally in the field of computerized aspects of debt management plan requests. More particularly, the technical field relates to intermediary computer processing and Internet-based computing, along with automated generation of related documentation, inter-computer communications, and networking.

### APPENDIX

This patent application includes Appendix with code on a CD. The two CDs filed herewith are identical and are incorporated by reference herein. All files are ASCII compliant and can be opened in a standard text editor, and program type is what was used for their creation. The machine format is IBM-PC, the operating system compatibility is Microsoft Windows and a list of the files contained on the CD-Roms, including their names, sizes in bytes, and dates of creation is as follows:

| | | | | |
|---|---|---|---|---|
| | Size | | | |
| Creation | in | | | Program |
| Date | bytes | Name of file | Description | Type |

Directory of \databaseFiles

| | | | | Text |
|---|---|---|---|---|
| | | | This visual basic | Editor/Import |
| | | | file can be used to | using |
| | 341,852 | MCFileDownLoadPeregrin | reconstruct the | SQL |
| Aug. 29, 2003 | | OnlineLive.bas | download | Server |
| | | | | Text |
| | | | This visual basic | Editor/Import |
| | | | file manages the | using |
| | | MCFileDownloadManagerLive | download program | SQL |
| Aug. 29, 2003 | 6,855 | .bas | for multiple files | Server |
| | | | | Text |
| | | | | Editor/Import |
| | | | This visual basic | using |
| | | MCFileUploadPeregrinOnline | file creates upload | SQL |
| Aug. 29, 2003 | 76,455 | Live.bas | files | Server |
| | | | This file contains | |
| | | | the structure of the | |
| | | | Microsoft SQL | |
| | | | database in SQL | |
| | | | command | Text |
| | | | structure along | Editor/Import |
| | | | with stored | using |
| | 172,602 | | procedures and | SQL |
| Aug. 29, 2003 | | epdms.sql | constraints | Server |
| | | | These are the cold | |
| Dir ctory of | | | fusion files that | |
| \wwwr t | | | run the interface | |
| | | | and enforce the | |
| | | | business rules | |
| | | | Used by creditors | |
| | | | to search for | Cold |
| Aug. 29, 2003 | 15,246 | AgencyList.cfm | agency info | Fusion |
| | | | Module used to | |
| | | DefSearch_AppendCriteria.cfm | help create | Cold |
| Aug. 29, 2003 | 1,715 | | queries | Fusion |
| | | | | Cold |
| Aug. 29, 2003 | 2,903 | Error.cfm | Default error page | Fusion |
| | | | Page used to | |
| | | | format | |
| | | | transactions for | Cold |
| Aug. 29, 2003 | 17,135 | PrintDoc.cfm | printing | Fusion |
| | | | Page used to get | |
| | | | Balance | |
| | | | Verifications for | |
| | | | display on | Cold |
| Aug. 29, 2003 | 6,961 | ReviewBalVers.cfm | Review.cfm | Fusion |
| | | | Page used to get | |
| | | | Deferred Balance | |
| | | | Verifications for | |
| | | | display on | Cold |
| Aug. 29, 2003 | 13,924 | ReviewDefBalVers.cfm | Review.cfm | Fusion |
| | | | Page used to get | |
| | | | Deferred Drops for | |
| | | | display on | Cold |
| Aug. 29, 2003 | 13,030 | ReviewDefDrops.cfm | Review.cfm | Fusion |
| | | | Page used to get | |
| | | | Deferred | |
| | | | Proposals for | |
| | | | display on | Cold |
| Aug. 29, 2003 | 18,696 | ReviewDefers.cfm | Review.cfm | Fusion |
| | | | Processes all | |
| | | | decisions made by | |
| | | | creditor users and | Cold |
| Aug. 29, 2003 | 31,816 | UpdateProps.cfm | updates database | Fusion |
| | | | Standard | |
| | | | Cascading Style | |
| | | | sheet, used in the | Cold |
| Aug. 29, 2003 | 1,190 | admin.css | Admin pages | Fusion |
| | | | small javascript to | Cold |
| Aug. 29, 2003 | 678 | admin.js | search a list | Fusion |
| | | | sets datasource | Cold |
| Aug. 29, 2003 | 465 | application.cfm | and error handling | Fusion |
| | | | Displays | |
| | | | transaction by type | Cold |
| Aug. 29, 2003 | 9,307 | countProps.cfm | and by portfolio | Fusion |
| | | | allows user to | |
| | | | select portfolio | |
| | | | Contains most of | |
| | | ePDMSStdMgmtReports1.cfm | the creditor | Cold |
| Aug. 29, 2003 | 60,961 | | reports | Fusion |
| | | | Verifies user and | |
| | | | updates session | |
| | | | variables also | |
| | | | contains | |
| | | | commonly used | |
| | | | javascripts and | |
| | | | controls automatic | Cold |
| Aug. 29, 2003 | 3,242 | epdmsHeader.cfm | logout | Fusion |
| | | | summary report | |
| | | | used by | Cold |
| Aug. 29, 2003 | 4,758 | epdmscounts.cfm | management | Fusion |
| | | | after successful | |
| | | | login opens | |
| | | | creditor's new | Cold |
| Aug. 29, 2003 | 415 | epdmsredirect.cfm | window | Fusion |
| | | | displays Creditor | Cold |
| Aug. 29, 2003 | 999 | fbc.cfm | List | Fusion |
| | | | displays Budget | Cold |
| Aug. 29, 2003 | 1,022 | fbd.cfm | Info | Fusion |
| | | | Main login page | |
| | | | where all users | |
| | | | enter username | Cold |
| Aug. 29, 2003 | 2,803 | login.cfm | and password | Fusion |
| | | | processes, | |
| | | | validates, and | |
| | | | directs users | Cold |
| Aug. 29, 2003 | 3,969 | loginvalidation.cfm | logging in | Fusion |
| | | | clears session | |
| | | | variables and | |
| | | | closes work | Cold |
| Aug. 29, 2003 | 1,011 | logout.cfm | window | Fusion |
| | | | popup used to | |
| | | | warm users of | |
| | | | impending | Cold |
| Aug. 29, 2003 | 769 | logoutwarning.cfm | automatic logout | Fusion |
| | | | Summary screen | |
| | | | used to display | |
| | | | available | |
| | | | transactions to | |
| | | | process includes | Cold |
| Aug. 29, 2003 | 2,667 | members.cfm | summary.cfm | Fusion |
| | | | equivalent to | |
| | | | members.cfm but | Cold |
| Aug. 29, 2003 | 2,814 | pageControl.cfm | for initial login | Fusion |
| | | | includes | |
| | | | summary.cfm | |
| | | | redirection page | |
| | | | used to open | |
| | | | agency processing | Cold |
| Aug. 29, 2003 | 426 | pereginonlineredirect.cfm | window | Fusion |
| | | | main page used to | |
| | | | display information | Cold |
| Aug. 29, 2003 | 24,092 | review.cfm | to creditor users | Fusion |
| | | | Page used to get | |
| | | | Drops for display | Cold |
| Aug. 29, 2003 | 6,451 | reviewDrops.cfm | on Review.cfm | Fusion |
| | | | Page used to get | |
| | | | Proposals for | |
| | | | display on | Cold |
| Aug. 29, 2003 | 10,110 | review News.cfm | Review.cfm | Fusion |
| | | | displays | |
| | | | information from | |
| | | | members.cfm and | |
| | | | pageControl.cfm | |
| | | | to give user | Cold |
| Aug. 29, 2003 | 9,457 | summary.cfm | options | Fusion |
| | | | Collection of | |
| | | | screen tips used | |
| | | | by creditor | Cold |
| Aug. 29, 2003 | 4,273 | tips.cfm | interface | Fusion |
| | | | Screen allows for | |
| | | | setting custom | |
| | | | colors and | |
| | | | adjusting screen | Cold |
| Aug. 29, 2003 | 4,582 | userOptions.cfm | size | Fusion |
| | | | This is the cold | |
| | | | fusion internal | |
| | | | interface for the | |
| Directory of \wwwroot\Admin | | | system | |
| | | | | Cold |
| | | | | Fusion |
| | | | Module used to | |
| | | | help create | Cold |
| Aug. 29, 2003 | 1,819 | AppendCriteria.cfm | queries | Fusion |
| | | | Processing done | |
| | | | to add a new | |
| | | | agency User, calls | Cold |
| Aug. 29, 2003 | 1,820 | addAgyUser.cfm | agyuserForm.cfm | Fusion |
| | | | Processing done | |
| | | | to add a new | |
| | | | Association calls | Cold |
| Aug. 29, 2003 | 629 | addAssoc.cfm | assocForm.cfm | Fusion |
| | | | Processing done | |
| | | | to add a new Biller | |
| | | | calls | Cold |
| Aug. 29, 2003 | 1,549 | addBiller.cfm | billerForm.cfm | Fusion |
| | | | Processing done | |
| | | | to add a new | |
| | | | creditor user calls | Cold |
| Aug. 29, 2003 | 1,598 | addCrdUser.cfm | crdUserForm.cfm | Fusion |
| | | | Processing done | |
| | | | to add a new | |
| | | | creditor calls | Cold |
| Aug. 29, 2003 | 1,123 | addCreditor.cfm | creditorForm.cfm | Fusion |
| | | | Search done to | |
| | | | find an agency to | |
| | | | add a DBA calls | Cold |
| Aug. 29, 2003 | 8,022 | add DBA.cfm | addNewDBA.cfm | Fusion |
| | | | Processing done | |
| | | | to add a new | |
| | | | outsourcing firm | |
| | | | calls | |
| | | | outsourcerForm.cfm | Cold |
| Aug. 29, 2003 | 585 | addOutsourcer.cfm | | Fusion |
| | | | Main page that | |
| | | | allows access to | |
| | | | add and edit | Cold |
| Aug. 29, 2003 | 2,049 | adminAddEdit.cfm | pages | Fusion |
| | | | Main page that | |
| | | | gives a summary | Cold |
| Aug. 29, 2003 | 1,671 | adminHome.cfm | report and news | Fusion |
| | | | Page used for | |
| | | | administration | Cold |
| Aug. 29, 2003 | 917 | adminLogin.cfm | login | Fusion |
| | | | Page used to give | |
| | | | access to | |
| | | | management | Cold |
| Aug. 29, 2003 | 1,725 | adminReports.cfm | reports | Fusion |
| | | | Page allows admin | |
| | | | users to search | Cold |
| Aug. 29, 2003 | 1,297 | adminSearch.cfm | parts of database | Fusion |
| | | | Processing done | |
| | | | to add a new | |
| | | | agency user calls | Cold |
| Aug. 29, 2003 | 5,072 | agyUserForm.cfm | agyUserForm.cfm | Fusion |
| | | | Displays | |
| | | | association data | |
| | | | for insert and | Cold |
| Aug. 29, 2003 | 3,779 | assocForm.cfm | update | Fusion |
| | | | | Cold |
| Aug. 29, 2003 | 4,939 | billerForm.cfm | Displays biller data | Fusion |
| | | | Displays creditor | Cold |
| Aug. 29, 2003 | 4,675 | crdUserForm.cfm | user data | Fusion |
| | | | Displays creditor | Cold |
| Aug. 29, 2003 | 5,704 | creditorForm.cfm | data | Fusion |
| | | | | Cold |
| Aug. 29, 2003 | 11,371 | dbaForm.cfm | displays DBA data | Fusion |
| | | | Allows for editing | |
| | | | of general DBA | Cold |
| Aug. 29, 2003 | 7,141 | dbaForm1.cfm | data | Fusion |
| | | | Allows for editing | |
| | | | of contact | Cold |
| Aug. 29, 2003 | 20,670 | dbaForm2.cfm | information | Fusion |
| | | | Allows for editing | |
| | | | of detailed DBA | Cold |
| Aug. 29, 2003 | 28,037 | dbaForm3.cfm | data | Fusion |
| | | | Summary of | |
| | | | agency from | Cold |
| Aug. 29, 2003 | 4,135 | displayAgency.cfm | search | Fusion |
| | | | Detailed info after | Cold |
| Aug. 29, 2003 | 15,935 | displayAgencyDetails.cfm | summary | Fusion |
| | | | creates billing | Cold |
| Aug. 29, 2003 | 4,842 | epdmsBilling.cfm | report | Fusion |
| | | | | Cold |
| Aug. 29, 2003 | 62 | footer.cfm | | Fusion |
| | | | Used to control | |
| | | | login and | Cold |
| Aug. 29, 2003 | 1,671 | header.cfm | navigation bar | Fusion |
| | | | | Cold |
| Aug. 29, 2003 | 1,749 | header.htm | | Fusion |
| | | | | Cold |
| Aug. 29, 2003 | 46 | index.cfm | | Fusion |
| | | | Used to make | |
| | | | PDFs available on | Cold |
| Aug. 29, 2003 | 712 | movepdf.cfm | the website | Fusion |
| | | | Displays | Cold |
| Aug. 29, 2003 | 3,690 | outsourcerForm.cfm | outsourcer data | Fusion |
| | | | Allows for PDF to | |
| | | | be uploaded and | Cold |
| Aug. 29, 2003 | 1,532 | pdfupload.cfm | named properly | Fusion |
| | | | Contains several | |
| | | | management | Cold |
| Aug. 29, 2003 | 17,620 | processing Reports.cfm | reports | Fusion |
| | | | takes PDF out of | Cold |
| Aug. 29, 2003 | 191 | removepdf.cfm | webspace | Fusion |
| | | | Search used by | |
| | | | management to | |
| | | | research agency | Cold |
| Aug. 29, 2003 | 7,511 | searchAgency.cfm | data | Fusion |
| | | | Search will be | |
| | | | used to find | |
| | | | specific | Cold |
| Aug. 29, 2003 | 1,463 | searchConsumer.cfm | transactions | Fusion |
| | | | Allows for updates | |
| | | | to existing Agency | Cold |
| Aug. 29, 2003 | 8,893 | updateAgyUser.cfm | users | Fusion |
| | | | Allows for updates | |
| | | | to existing | Cold |
| Aug. 29, 2003 | 4,583 | updateAssoc.cfm | Associations | Fusion |
| | | | Allows for updates | Cold |
| Aug. 29, 2003 | 6,039 | updateBiller.cfm | to existing Billers | Fusion |
| | | | Allows for updates | |
| | | | to existing Creditor | Cold |
| Aug. 29, 2003 | 10,088 | updateCrdUser.cfm | Creditors | Fusion |
| | | | Allows for updates | |
| | | | to existing | Cold |
| Aug. 29, 2003 | 5,083 | updateCreditor.cfm | Creditors | Fusion |
| | | | Allows for updates | |
| Aug. 29, 2003 | 15,336 | updateDBA.cfm | to existing DBAs | Fusion |
| | | | Allows for updates | |
| | | | to existing | Cold |
| Aug. 29, 2003 | 4,544 | updateOutsourcer.cfm | Outsourcers | Fusion |
| | | | This is used to | |
| | | | store scripts the | |
| Directory of \wwwroot\Admin\dataChecks | | | check the data | |
| | | | Checks for | |
| | | | unknown agnecy's | Cold |
| Aug. 29, 2003 | 961 | agency_biller.cfm | and billers | Fusion |
| | | | This is the agency | |
| | | | interface section | |
| Directory of \wwwroot\PeregrinOnline | | | of Peregrin Online | |
| | | | Form used to add | Cold |
| Aug. 29, 2003 | 5,421 | addFBC.cfm | creditor lists | Fusion |
| | | | Form used to add | Cold |
| Aug. 29, 2003 | 3,492 | addFBD.cfm | Budget info | Fusion |
| | | | Processing to edit | Cold |
| Aug. 29, 2003 | 3,046 | agencyEdit.cfm | agnecy info | Fusion |
| | | | Form used to | |
| | | | display agency | Cold |
| Aug. 29, 2003 | 8,878 | agencyEditForm.cfm | info | Fusion |
| | | | Form used to | Cold |
| Aug. 29, 2003 | 2,615 | cddForm.cfm | enter Drops | Fusion |
| | | | | Cold |
| Aug. 29, 2003 | 2,213 | cddProcessing.cfm | Processes drops | Fusion |
| | | | Collects multiple | Cold |
| Aug. 29, 2003 | 7,455 | cdpBillerForm.cfm | billers for a DMP | Fusion |
| | | | Allows user to | |
| | | | enter consumer | Cold |
| Aug. 29, 2003 | 4,039 | cdpCustomerInfoForm.cfm | information | Fusion |
| | | | creates all | |
| | | | transactions for | Cold |
| Aug. 29, 2003 | 8,728 | cdpProcessing.cfm | the DMP | Fusion |
| | | | | Cold |
| Aug. 29, 2003 | 8,726 | cdpSummary.cfm | Summarizes DMP | Fusion |
| | | | Form used to | |
| | | | enter Balance | Cold |
| Aug. 29, 2003 | 2,846 | cdvForm.cfm | Verifications | Fusion |
| | | | Enters | |
| | | | Verifications into | Cold |
| Aug. 29, 2003 | 2,371 | cdvProcessing.cfm | system | Fusion |
| | | | Allows user to see | |
| | | | information about | Cold |
| Aug. 29, 2003 | 1,392 | displayMask.cfm | biller masks | Fusion |
| | | | controls session | |
| | | | variables and | Cold |
| Aug. 29, 2003 | 518 | logout.cfm | closes screen | Fusion |
| | | | popup used to | |
| | | | warn users of | |
| | | | impending | Cold |
| Aug. 29, 2003 | 769 | logoutwarning.cfm | automatic logout | Fusion |
| | | | main screen for | Cold |
| Aug. 29, 2003 | 3,953 | mainMenu.cfm | navigation | Fusion |
| | | | Displays | |
| | | | transactions that | Cold |
| Aug. 29, 2003 | 3,260 | pendingSummary.cfm | are pending | Fusion |
| | | | allows user to go | |
| | | | to main screen or | |
| | | | logout from every | Cold |
| Aug. 29, 2003 | 681 | perOnlineFooter.cfm | screen | Fusion |
| | | | checks user status | Cold |
| Aug. 29, 2003 | 2,043 | perOnlineHeader.cfm | and sets variables | Fusion |
| | | | gives details of a | |
| | | | Balance | Cold |
| Aug. 29, 2003 | 1,940 | returnedBalDetail.cfm | Verification | Fusion |
| | | | gives details of a | Cold |
| Aug. 29, 2003 | 3,359 | returnedPropDetail.cfm | Proposal | Fusion |
| | | | Displays | |
| | | | transactions that | |
| | | | have been | Cold |
| Aug. 29, 2003 | 4,938 | returnedSummary.cfm | returned | Fusion |
| | | | Directory used to | |
| Directory of \wwwr ot\autofil | | | present files for | |
| | | | download online | |
| | | | Allows users to | Cold |
| Aug. 29, 2003 | 2,030 | agylistupload.cfm | upload specific file | Fusion |
| | | | Creates files for | Cold |
| Aug. 29, 2003 | 6,351 | createfile.cfm | download | Fusion |
| | | | Imports files to | |
| | | | database that | |
| | | | have been | Cold |
| Aug. 29, 2003 | 11,200 | importfile.cfm | uploaded | Fusion |
| | | | allows user to | Cold |
| Aug. 29, 2003 | 2,270 | transdownload.cfm | download files | Fusion |
| | | | allows user to | Cold |
| Aug. 29, 2003 | 3,241 | transupload.cfm | upload file | Fusion |
| | | | These files run the | |
| | | | messaging feature | |
| Directory of \wwwroot\mail | | | for creditors | |
| | | | displays a | Cold |
| Aug. 29, 2003 | 363 | Readmail.cfm | message | Fusion |
| | | | popup for creation | Cold |
| Aug. 29, 2003 | 3,249 | cfmail.cfm | of messages | Fusion |
| | | | checks email | Cold |
| Aug. 29, 2003 | 2,011 | email_validation.cfm | addresses | Fusion |
| | | | checks mailboxes | Cold |
| Aug. 29, 2003 | 2,205 | epdms_email_check.cfm | and imports mail | Fusion |
| | | | formats messages | Cold |
| Aug. 29, 2003 | 1,492 | mailPrintFormat.cfm | for printing | Fusion |
| | | | displays available | |
| | | | messages to | Cold |
| Aug. 29, 2003 | 8,425 | mailbox.cfm | users | Fusion |
| | | | shows all | |
| | | | messages for a | Cold |
| Aug. 29, 2003 | 1,474 | readRecord.cfm | record | Fusion |
| | | | shows a single | Cold |
| Aug. 29, 2003 | 740 | readSingle.cfm | message | Fusion |
| | | | function that | |
| | | | actually sends | Cold |
| Aug. 29, 2003 | 1,679 | sendMail.cfm | mail | Fusion |
| | | | allows users to | |
| | | | see info about a | |
| | | | transaction that | |
| | | | has already been | Cold |
| Aug. 29, 2003 | 17,918 | viewDecision.cfm | processed | Fusion |
| | | | Directory for | |
| Dir ctory of \wwwroot\r ports | | | additional reports | |
| | | | Report to get | |
| | | | transaction level | |
| | | | details for a | Cold |
| Aug. 29, 2003 | 10,380 | ePDMSDetailedReport.cfm | creditor | Fusion |
| | | | Directory for | |
| | | | custom color | |
| Directory of \wwwroot\stylesheets | | | settings | |
| | | | Standard | |
| | | | Cascading Style | Cold |
| Aug. 29, 2003 | 1,744 | agency.css | Sheet | Fusion |
| | | | Standard | |
| | | | Cascading Style | Cold |
| Aug. 29, 2003 | 1,744 | arctic.css | Sheet | Fusion |
| | | | Standard | |
| | | | Cascading Style | Cold |
| Aug. 29, 2003 | 1,744 | arizona.css | Sheet | Fusion |
| | | | Standard | |
| | | | Cascading Style | Cold |
| Aug. 29, 2003 | 1,744 | bahama.css | Sheet | Fusion |
| | | | Standard | |
| | | | Cascading Style | Cold |
| Aug. 29, 2003 | 1,744 | bannanna.css | Sheet | Fusion |
| | | | Standard | |
| | | | Cascading Style | Cold |
| Aug. 29, 2003 | 1,744 | beige.css | Sheet | Fusion |
| | | | Standard | |
| | | | Cascading Style | Cold |
| Aug. 29, 2003 | 1,744 | chili.css | Sheet | Fusion |
| | | | Standard | |
| | | | Cascading Style | Cold |
| Aug. 29, 2003 | 1,744 | cocoa.css | Sheet | Fusion |
| | | | Standard | |
| | | | Cascading Style | Cold |
| Aug. 29, 2003 | 1,744 | forest.css | Sheet | Fusion |
| | | | Standard | |
| | | | Cascading Style | Cold |
| Aug. 29, 2003 | 1,744 | lime.css | Sheet | Fusion |
| | | | Standard | |
| | | | Cascading Style | Cold |
| Aug. 29, 2003 | 1,744 | sherbert.css | Sheet | Fusion |
| | | | Standard | |
| | | | Cascading Style | Cold |
| Aug. 29, 2003 | 1,742 | standard.css | Sheet | Fusion |
| | | | Standard | |
| | | | Cascading Style | Cold |
| Aug. 29, 2003 | 1,744 | steel.css | Sheet | Fusion |

### BACKGROUND OF THE INVENTION

Consumers who are experiencing financial difficulties seek out the services of Consumer Credit Counseling agencies or other Financial Assistance Centers for help restructuring their debt. These organizations interview the consumer, conduct a budget review/analysis, and enroll qualified consumers into Debt Management Plans. The enrollment process can involve a formal request/application submitted to each creditor to whom the consumer is requesting some measure of relief. The two traditional methods for submitting such requests is either by mail service or to use the services of an electronic payment processor such as MasterCard RPPS™ or Visa ePay™.

When mail service is used to submit the applications the process can take in excess of one week (most cases longer) to complete versus submitting electronically, which shortens the cycle to usually 24 hours. The cost to use mail service is substantially higher then electronic submit because of ever-increasing postage costs, paper, envelops, employee costs to print out forms, stuff envelops, open envelops, sort, process, and storage of the applications. Additionally, the burden of manually tracking the activity and producing activity reports is substantial. The benefits of electronic submission of the same applications are numerous, lower cost of operations including postage, handling, personnel, storage, and the process time is significantly reduced.

The initial cost to use the services of an electronic payment processor is high with the additional requirement or burden of developing the interface between the processor and the originator's software system. A high percentage of organizations use the services of an intermediary service provider (Concentrator or Bill Service Provider) as a channel to one or a multiple of electronic payment processors.

Creditors are also faced with the same interface requirements as the originators, they must make the same investment in terms of time, resources, and infrastructure in order to receive and process applications electronically.

In view of the foregoing, an object of the invention is to improve over some or all of the drawbacks indicated herein. This and other objects and advantages of this invention will become apparent from a consideration of the figures and ensuing description in contrast to the state of the art before the present invention.

### SUMMARY OF THE INVENTION

The present invention radically changes the dynamics of the above-described process. Whereas the prior approach had originators and receivers supporting, the present invention allows an originator or a receiver to process these transactions electronically using a computer network, such as the Internet, in a secure manner. This approach eliminates the cost and burden of development, personnel, and infrastructure for both originators and receivers. The present invention also supports a multitude of data communications packages such as MasterCard RPPS™ and Visa ePay™.

The present invention encompasses interfacing, receiving, and processing electronic debt management request proposals (DMPs) and other related requests from an originator, concentrator, or Bill Service Provider of such requests. The present invention also encompasses presenting a Graphical User Interface (GUI), using a secure, online computer network such as the Internet or other similar direct access to an institution or organization that has a vested interest, extents credit, processes payments or performs collection activity on pass-due accounts.

Additionally, the present invention can allow multiple electronic payment processors, such as MasterCard RPPS™ and Visa ePay™ that use different communications control formats, protocols, and data file specification, to transmit electronically, debt management proposals or similar requests to a single source for presentment to a multitude of credit grantors, payment processors and collections companies. Again, this can preferably be carried out using a secure, online computer network such as the Internet or similar direct access method.

Further, the present invention can allow an originator of such requests/applications to submit the same using a GUI for presentation to a multitude of credit grantors, payment processors and collections companies, again by using a secure, online computer network such as the Internet or similar direct access method.

Also, the present invention provides a secure, online, and consistent method for originating, receiving and processing electronic requests while eliminating a need to develop custom interfaces, invest in expensive proprietary solutions, utilizing suitable resources for connection to a secure computer network such as the Internet or other similar direct connection.

Further detail is provided in the drawings and detailed discussion set out below.

### BRIEF DESCRIPTION OF THE DRAWINGS

FIG. 1 is an illustration of hardware in accordance with the present invention.

FIG. 2 is an illustration of method steps for making, in accordance with the present invention.

FIG. 3 is an illustration of method steps for using, in accordance with the present invention.

FIG. 4 is an illustration of a menu.

FIG. 5 is an illustration of a flow chart for Review/Enter a new Proposal.

FIG. 6 is an illustration of a flow chart for Request/Provide a Balance Verification.

FIG. 7 is an illustration of a flow chart for Drop a consumer from the program.

FIG. 8 is an illustration of a flow chart for Agency Administration.

FIG. 9 is an illustration of a flow chart for Reports.

FIG. 10 is an illustration of a flow chart for Proposal Management.

FIG. 11 is an illustration of a Log In Screen.

FIG. 12 is an illustration of a Logging in Screen.

FIG. 13 is an illustration of a Transaction Screen.

FIG. 14 is an illustration of a Processing Proposals Screen.

FIG. 15 is an illustration of a second Processing Proposals Screen.

FIG. 16 is an illustration of a third Proposal Processing Screen.

FIG. 17 is an illustration of a fourth Proposal Processing Screen.

FIG. 18 is an illustration of a fifth Proposal Processing Screen.

FIG. 19 is an illustration of a sixth Proposal Processing Screen.

FIG. 20 is an illustration of a Creditor Information Screen.

FIG. 21 is an illustration of a Budget Information Screen.

FIG. 22 is an illustration of a Main Proposal Screen.

FIG. 23 is an illustration of a Approve a Proposal Screen.

FIG. 24 is an illustration of a Decline a Proposal Screen.

FIG. 25 is an illustration of a Defer a Proposal Screen.

FIG. 26 is an illustration of a Retrieving Deferred Proposals Screen.

FIG. 27 is an illustration of a Deferred Proposal Search Screen.

FIG. 28 is an illustration of a Deferred Proposals Screen.

FIG. 29 is an illustration of a second Deferred Proposals Screen.

FIG. 30 is an illustration of a Message Function Screen.

FIG. 31 is an illustration of a Creating a Message Screen.

FIG. 32 is an illustration of a Creating a second Message Screen.

FIG. 33 is an illustration of a Processing Options Screen.

FIG. 34 is an illustration of a Message Responses Screen.

FIG. 35 is an illustration of a Viewing Message Responses Screen.

FIG. 36 is an illustration of a second Viewing Message Responses Screen.

FIG. 37 is an illustration of a third Viewing Message Responses Screen.

FIG. 38 is an illustration of a Decisioning Screen.

FIG. 39 is an illustration of a Agency Contact Information Screen.

FIG. 40 is an illustration of a Agency Search Screen.

FIG. 41 is an illustration of a second Agency Search Screen.

FIG. 42 is an illustration of a Agency Database Screen.

FIG. 43 is an illustration of a Drops Screen.

FIG. 44 is an illustration of a Balance Verifications Screen.

FIG. 45 is an illustration of a Reporting Screen.

FIG. 46 is an illustration of a Standard Reporting Screen.

FIG. 47 is an illustration of a second Standard Reporting Screen.

FIG. 48 is an illustration of a third Standard Reporting Screen.

FIG. 49 is an illustration of a fourth Standard Reporting Screen.

FIG. 50 is an illustration of a fifth Standard Reporting Screen.

FIG. 51 is an illustration of a Main Menu Screen.

FIG. 52 is an illustration of a Consumer Information Screen.

FIG. 53 is an illustration of a Add FBDs Screen.

FIG. 54 is an illustration of a Biller Information Screen.

FIG. 55 is an illustration of a Add FBCs Screen.

FIG. 56 is an illustration of a Proposal Summary Screen.

FIG. 57 is an illustration of a Proposal Sent Screen.

FIG. 58 is an illustration of a Consumer Information Screen.

FIG. 59 is an illustration of a Balance Verification Sent Screen.

FIG. 60 is an illustration of a Consumer Information Screen.

FIG. 61 is an illustration of a Consumer Drop Sent Screen.

FIG. 62 is an illustration of a Review Pending Proposals Screen.

FIG. 63 is an illustration of a Proposal Detail Screen.

FIG. 64 is an illustration of a Review Returned Proposals Screen.

FIG. 65 is an illustration of a Proposal Detail Screen.

FIG. 66 is an illustration of a Database Entity Relationship Diagram.

FIG. 67 is an illustration of a DTS Upload Diagram.

FIG. 68 is an illustration of a DTS Download Diagram.

### DESCRIPTION OF A REPRESENTATIVE PREFERRED EMBODIMENT

Turning now to a detailed discussion of the invention, and preferred embodiment, please refer to the code in the CD Appendix hereto, which is incorporated herein.

By way of an overview, the invention encompasses a method for Internet-based intermediary computing to handle debt management plan requests. The method can include the steps of: receiving respective debt management plan requests at an intermediary computer, preferably by Internet communication, from each of a plurality of request-originating computers. The intermediary computer handles processing the respective debt management plan requests to produce respective, formatted and at least partially validated debt management plan requests. These are used in enabling a respective debt management plan decision at one of the intermediary computer and/or a creditor computer. Electronically communicating a signal of said decision to the request-originating computer follows thereafter.

In one embodiment, the intermediary computer can be programmed to present an electronic form at the request originating computers. The electronic form is structured to induce inputting of respective debt management plan request information. Entering the respective debt management plan request information, responsive to the presented electronic form, at input devices operably connected respectively to the request-originating computers. This approach can recognizably structure the respective debt management plan requests for the intermediary computer. There follows the step of communicating the respective debt management plan requests from the request-originating computers to the intermediary computer to carry out the above-mentioned receiving.

Alternatively, or preferably in addition, an embodiment can handle file transfer. This involves programming the intermediary computer to receive a batch file communication of the respective debt management plan requests and structuring the respective debt management plan requests at the request-originating computers to produce a batch file communication recognizably structured for the intermediary computer. Again, there follows a communicating the respective debt management plan requests, by said file communication, from the request-originating computers to the intermediary computer to carry out the receiving.

Another aspect of the invention can involve forming an on-line (preferably in real time) presentation of said debt management plan decision requests, and conveying the on-line presentation from the intermediary computer to one of the request-originating computers to induce the respective debt management plan decision.

Yet another aspect can involve applying at least one rule in automatically producing one of the respective debt management plan request decision at the intermediary computer; and signaling the creditor computer of automatically produced decision. The rule can automatically produce a rejection as the debt management plan request decision, an acceptance, or preferably both, as well as flag situations that require further consideration.

The present invention can extend to the full consequences of intermediary computing, including providing status reports (and other reports) at said intermediary computer. The status report can correspond to at least one of said debt management requests, an aggregate of said debt management requests in a period of time, or preferably both.

Still further, the present invention can comprehend authorizing creditor computer access to the intermediary computer; authorizing request-originator computer access to the intermediary computer; and testing for at least one (better two, better three, etc. ) of the following criteria of a known: request originating computer, user, creditor, account number, and/or mask or format (or any combination thereof).

More so, the present invention comprehends providing a web site to facilitate at least one of the steps.

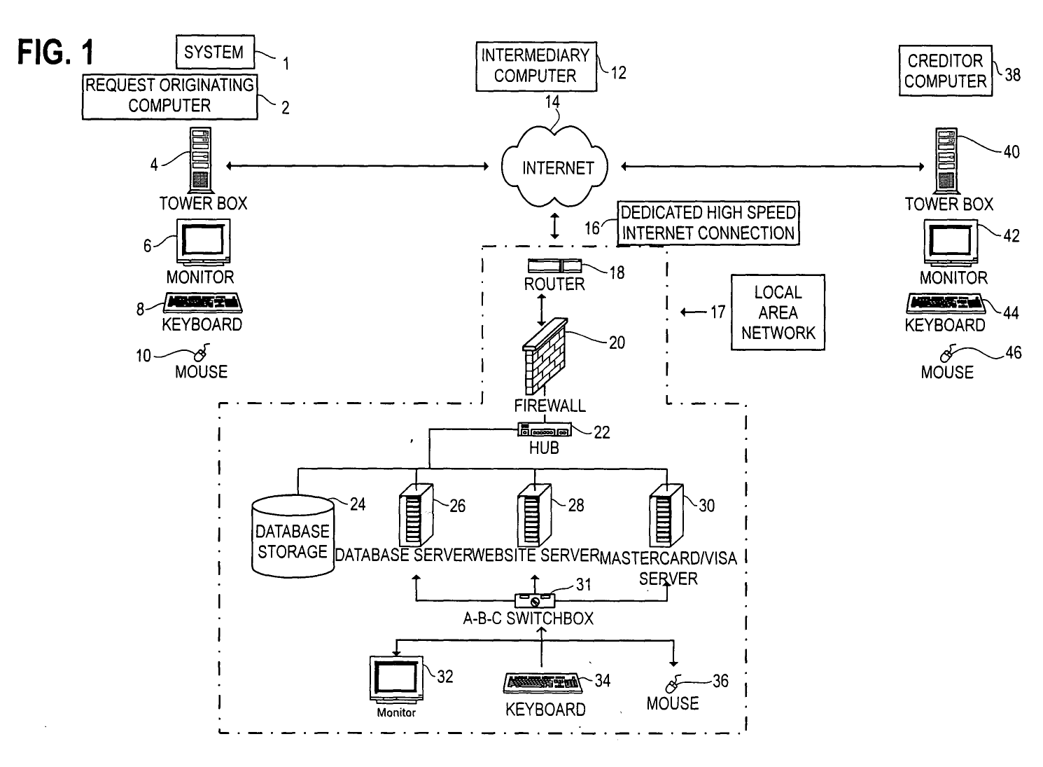

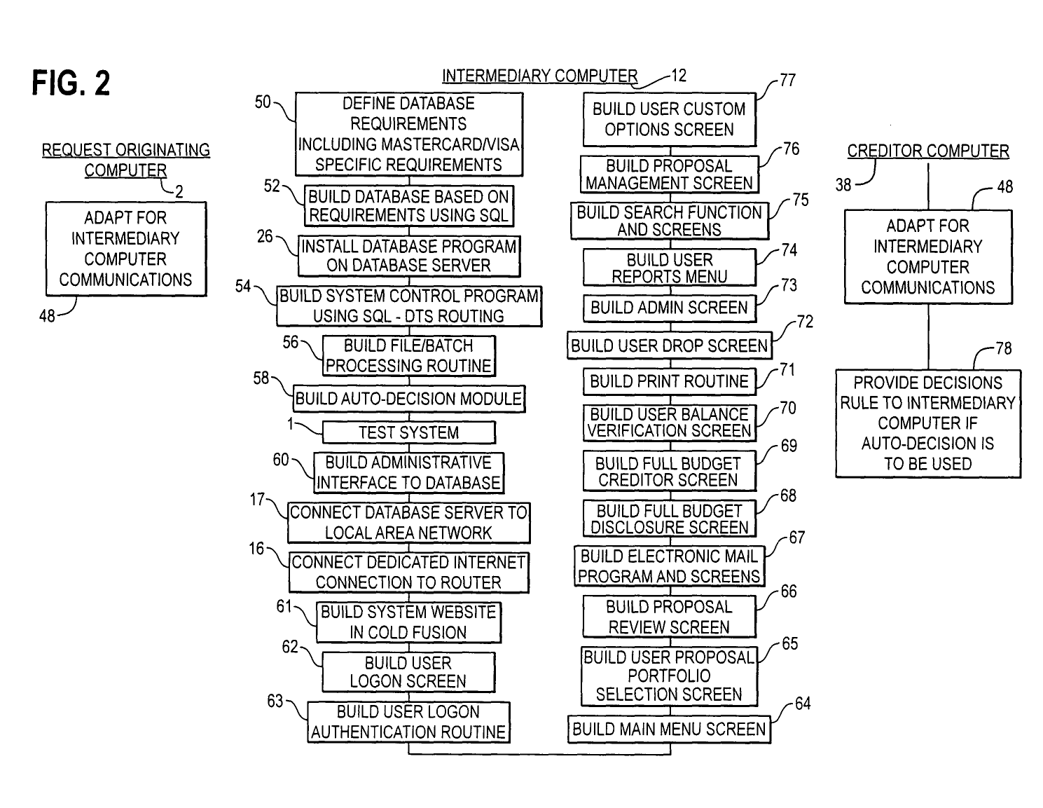

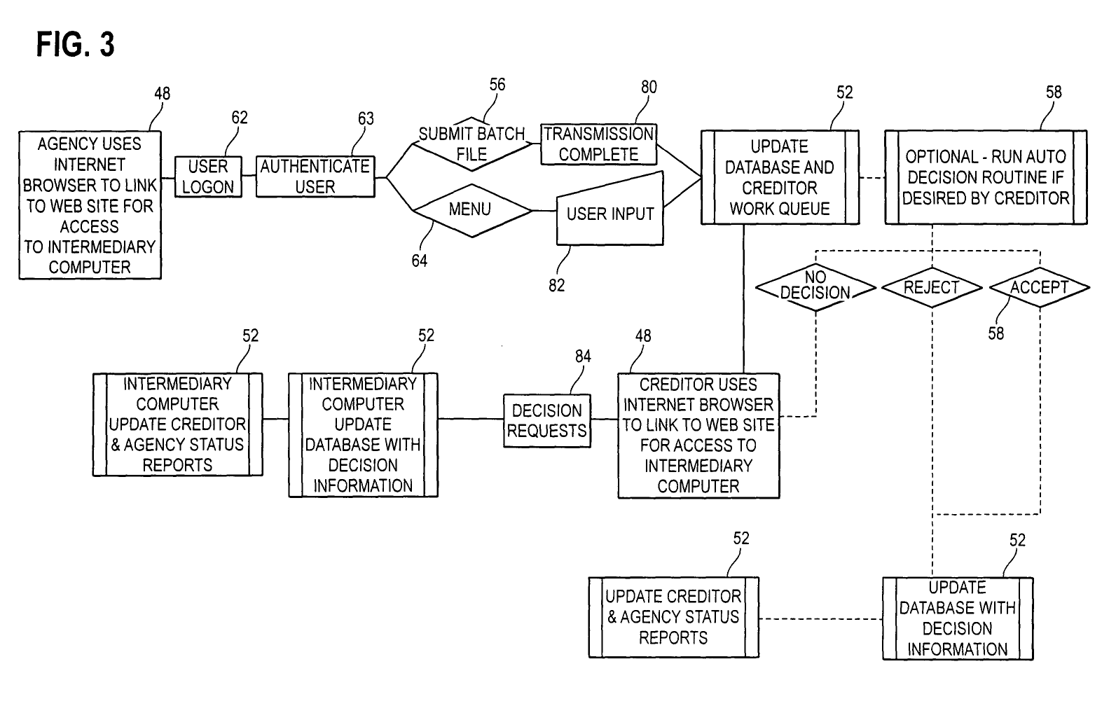

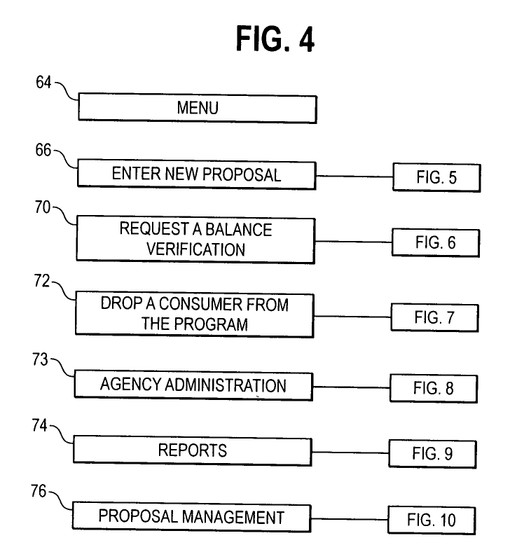

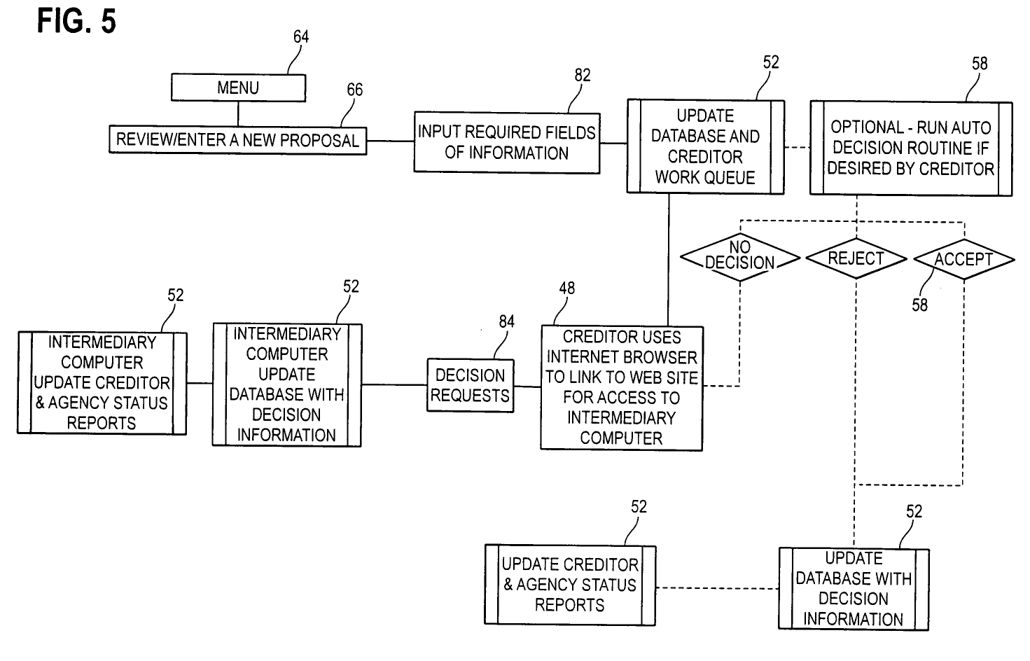

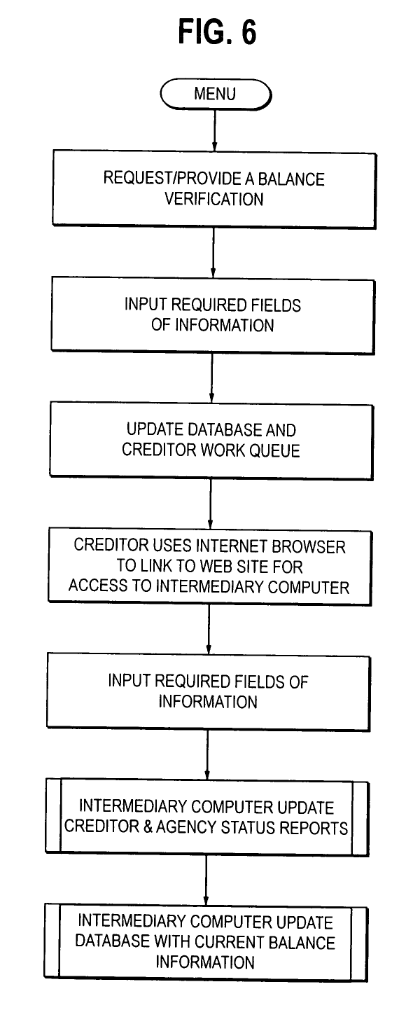

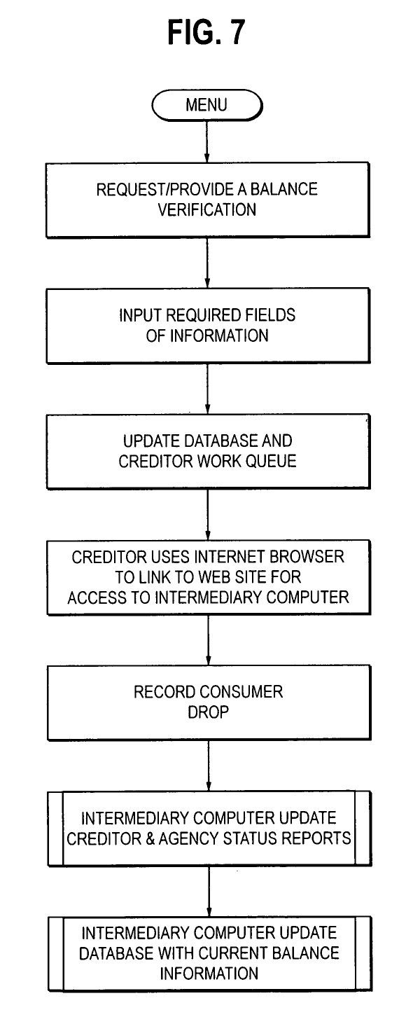

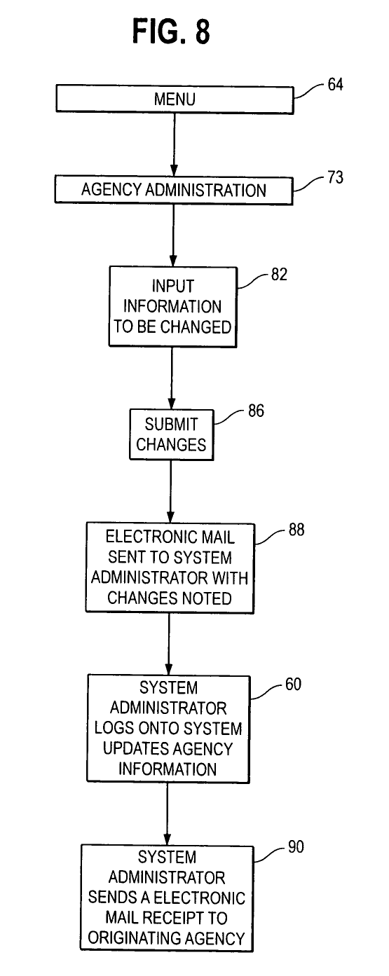

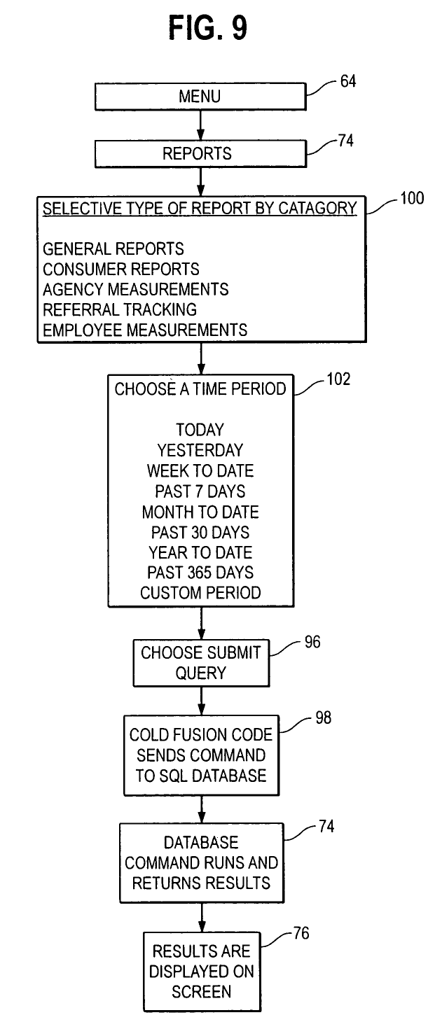

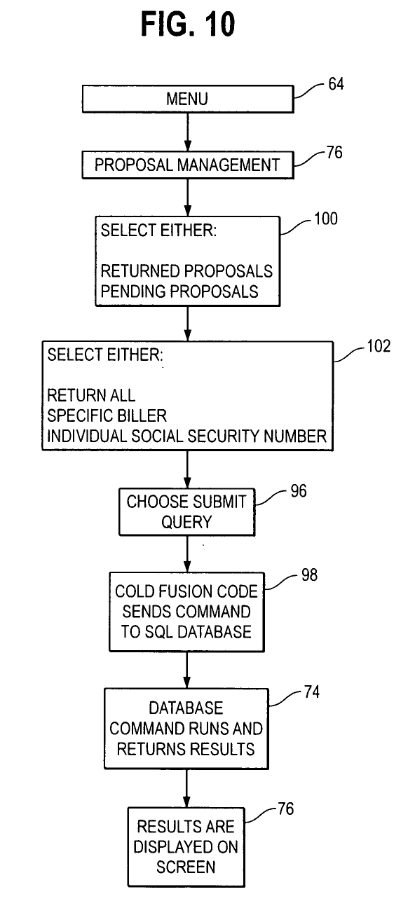

Further, with general reference to FIG. 1, the present invention can be carried out with components including at least one request originating computer 2 system, an intermediary computer 12 system, and at least one creditor computer 38 system.

Turning first to the intermediary computer 12 computing, for an overview of its operations, with a more detailed discussion to follow, the present invention can be carried out, for example, with four basic elements.

Computer Network 17

System control program 54

Database 52

GUI 61

Computer Network

For reasons of maximizing processing efficiency and workload balancing/sharing a Three-tier Architecture computer network 17 was constructed. A one or two-tier network will serve the same purpose but will experience diminished performance. The three-tier architecture separates the database services layer 26, the application services layer 30, and the presentation services layer 28. The three-tier application uses the middle layer to multiplex connections from the presentation services layer, which reduces the number of connections into the SQL Server. In addition, the middle layer will host and perform a great deal of the system/program logic, which allows the database services layer to handle just the transfer of data. An external Storage Area Network (SAN) 24 was selected to store data to minimize the growth of the database by moving old data/records yet remaining accessibility to those records.

1. Servers 4—dual processors, 500 Mhz or higher, 1 gig of memory, Ethernet cards.

a. GUI presentation services 28

b. Application services 30

c. Database services 26

d. Spare

2. Storage area network (150-gig)—external 24

3. Monitor—VGA—16,000 colors 32

4. Monitor console selector A/B/C switch 31

5. Keyboard 34

6. Mouse or other appropriate pointing device 36

7. 10/100 8-port Ethernet Hub 22

8. Firewall—allow outbound TCP traffic 20

9. Router 18

10. Dedicated connection to computer network such as the Internet, Virtual Private Network (VPN), Point-to-Point, or other similar connection. 16

11. Read/write CD-Rom

12. Appropriate cabling and connectors

13. Microsoft Windows 2000

14. Microsoft SQL 2000

15. Cold Fusion 5.0

System Control Program 54—(Application Services)

1. Retrieves data files from download directory.

2. Parses new data files into correct database(s) & database table(s), saves, and renames original file.

3. Performs error checking routine on received data files and prevents the program from posting the corrupted file/data and records the error.

4. Checks database (at pre-determined intervals) for processed files from Users and formats data for either Presentment or Upload to electronic payment processors in the proper format, protocol, and file specification.

5. Posts processed and formatted files into either database or Upload directory as per the type of transaction.

6. Records events in log event file.

7. Checks database for old processed files and achieve at pre-determined intervals.

8. System operation and status are monitored locally.

9. Uses a local connection to review, display, and process individual or records as desired.

10. Has build-in query capability to separate or segment data record types as desired.

11. Setup Download and Upload directories for data file exchange to and from electronic payment processors.

12. Install and setup communications control programs from various electronics payment processors.

Database—(Database Services)

1. Develop database with multiple tables to receive and store data files that meet, exceed, or conforms to the physical file characteristics and specifications of multiple electronic payment processors such as MasterCard RPPS™ or Visa ePay™ file specifications or others as may be desired.

2. Develop database 52 with multiple tables to receive and store data types associated with debt management proposals and other associated requests such as verification of account balances, consumer dropped from programs, consumer terminated from program.

3. Incorporate database tables 52 for identifying and registering Originators, Concentrators, Bill Service Providers, Receivers, and Users.

4. Incorporate database table 52 for recording unique User names and Passwords.

5. Incorporate database tables 52 for segmenting:

a. Record types

i. Proposals

ii. Accepted

iii. Rejected—with rejection codes

iv. Balance Inquire

v. Drops

vi. Terminations

b. Record dates

c. Originators

d. Receivers

e. Users

f. Consumer information

i. Name

ii. Social Security Number

iii. Address

iv. Home Phone

v. Work Phone

g. Creditor information

i. Account number

ii. Account balance

h. Status of requests

6. Incorporate query-on-demand and reporting capabilities 74.

7. Another function of the database is to be an information repository consisting of:

Agencies

Creditors

Consumers enrolled in debt management plans

Agencies

Various states such as California, Oregon, Michigan, and Maryland have licensing or registration requirements that must be met in order for an Agency to transact business within that state. Agencies are known as Debt Adjusters in one state, Debt Consolidators in another state, Credit Counseling Agencies in others. Collectively these entities must register or become licensed to conduct business within the state and meet certain requirements such as having a physical presence within the state or posting a surety bond. By compiling this registration information on an agency by agency level and then comparing to published lists for each state of agencies authorized to conduct business a business rule can be applied that would verify that an agency is authorized to submit debt management proposals for consumers within that state. Adherence to local, state and federal requirements is of importance to creditors to ensure compliance with the Gramm-Leach-Bliley Act, Public Law 106-102-Nov. 12, 1999. The state of origination is determined by comparing the pre-fix of the consumer home telephone number to the agency's physical address. If the agency is not authorized to conduct within that state of origination then a business rule could be applied that would reject the debt management proposal.

Agencies often have one legal name, transact business under another name and market under yet another name. Agencies often originate business under one name and submit debt management proposals under a different name usually through a servicing company, which may or may not be a not-for-profit entity. The function of the database is to give the User the ability to associate any of the possible combinations to the parent level. The database is designed to track all agencies or originators at this detail level.

Creditors

Creditors like agencies operate under many names and each has there own requirements to meet for the submission of debt management proposals. Some credits will only accept debt management proposals when a Full Budget Creditor or Full Budget Disclosure accompanies the request. Other Creditors do not want the Full Budget Creditor or Full Budget Disclosure except in cases of hardship. All the Creditors have different mailing addresses, pay different rates of fairshare and have different interest rate levels. The database is designed to exchange this information with the agencies and for agency information to be shared with the Creditors. The invention provides a common information and communication bridge between the agency and the creditor.

Consumers

Once a consumer has been approved for a debt management plan the database acts as a conduit between the enrolling agency and the participating creditor. The agency has informed the creditor when to except the first and subsequent payments from the consumers. Should a payment be missed the creditor can either individually or in a batch send immediate notification to the originating agency that a payment has been missed. The agency after investigating the incident can update the creditor, all by way of the build in message service.

Consider now the GUI presentation services as follows.

GUI Presentation Services—

1. GUI that allows User to submit, receive, review, decision and store debt management proposals or other related documents utilizing a secure, online computer network such as the Internet.

2. GUI presents data by:

a. Organization

b. Portfolio

c. Number of new records for review

d. Number of deferred records for review

e. By record type (both new and deferred)

3. GUI presents additional provided information such as:

a. Full Budget Creditor (FBCs)—creditors listed on the proposed debt management plan and proposed monthly payments

b. Full Budget Disclosure (FBDs)—consumer income, other expenses, and reason for hardship.

c. Originating organization

4. GUI retrieves and presents either one record at a time or multiple/batch records as determined by the User.

5. GUI utilizes Secure Socket Layering (SSL), and 128-bit encryption technology.

6. GUI is hosted on a secure website behind a firewall.

7. GUI has unique User names and Passwords for Users.

8. GUI automatically disconnects after a pre-determined ‘no activity period’.

9. GUI incorporates electronic mail (Email) as a means of enhancing communications between Originators and Receivers.

GUI provides a reporting module for User to obtain activity information.

With respect to request originating (e.g., agency) computer 2, from the Request Originating Computer 2 a User logs onto the System 1 by:

Opens Internet Explorer from their computer.

Types in the following URL: https//epdms.net

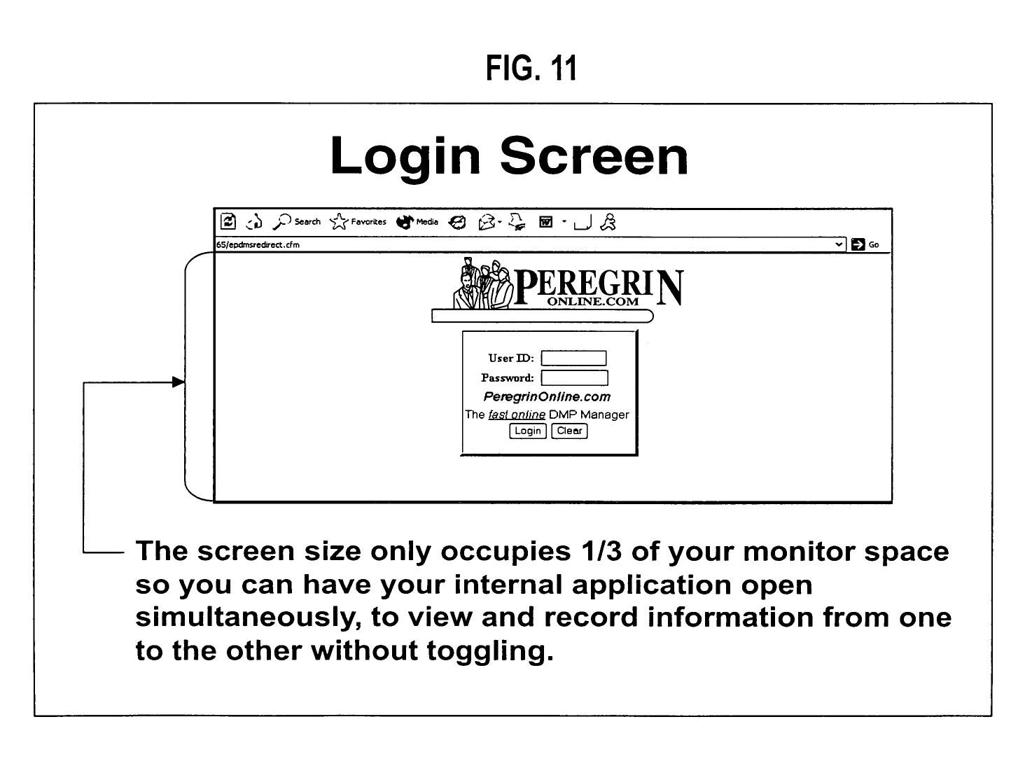

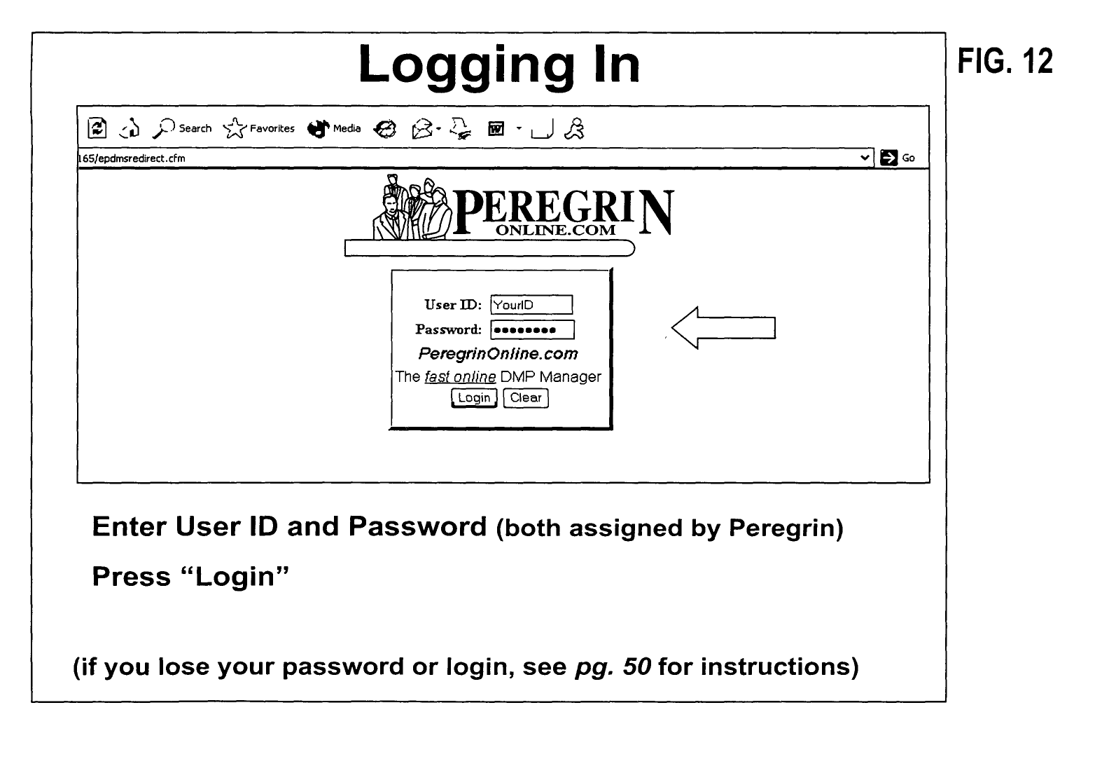

A logon screen FIG. 11 will appear, the User enters their User ID and Password as illustrated in FIG. 12 and clicks the ‘Login’ button with the mouse pointer 10. An Authentication routine 63 will run and authenticate the User and user permissions such as access to reports.

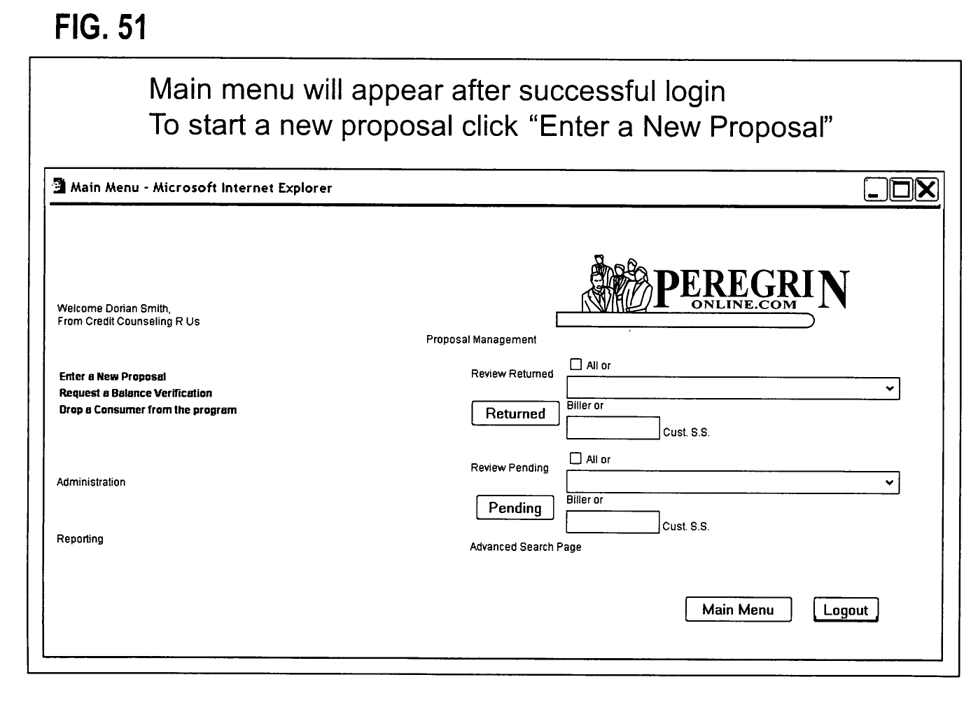

If the User ID cannot be authenticated a message will appear “User ID or Password incorrect, please try again”. If the User ID is authenticated, the Main Menu FIG. 51 will appear.

From the Main Menu FIG. 51 the User can perform the following actions:

Enter a New Proposal

Request a Balance Verification

Drop a Consumer from a debt management program

Proposal Management

Review Returned proposals

Review Pending proposals

Add Full Budget Disclosure

Clear Form

Log out of the System 1

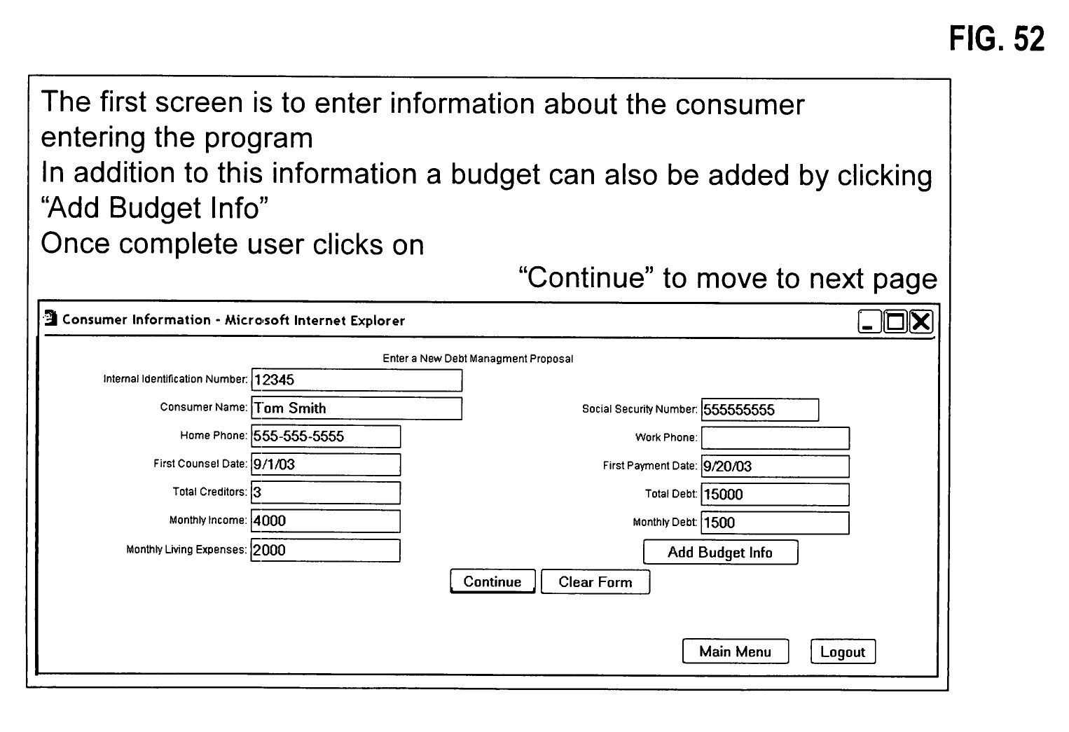

To enter a new proposal the User would click ‘Enter a New Proposal’ with the mouse pointer 10, the Consumer Information screen FIG. 52 would appear. The User would data enter the following Consumer Information:

Internal Identification Number

Consumer Name

Home Phone

First Counsel Date

Total Creditors

Monthly Income

Monthly Living Expenses

Social Security Number

Work Phone

First Payment Date

Total Debt

Monthly Debt

If the User desires to submit a Full Budget Disclosure with the Debt Management Plan the User clicks ‘Add Full Budget Disclosure’ button with the mouse pointer 10. The Add FBDs screen will appear and the User can select the components/items that make up the consumer's budget. Items can be selected from the Item field drop-down box such as:

Rent

Phone

Utilities

Food

Entertainment

Clothes

Laundry

Insurance

Auto Payment

After selecting an item the User inserts the amount for that item in the ‘Amount’ field and clicks the ‘Add Item’ to continue adding items. If an item is mistakenly entered it can be removed by clicking the ‘Remove Item’ button. After entering the desired items, the User clicks the ‘Return and Commit’ to attach the Full Budget Disclosure to the Consumer's Debt Management Proposal.

If the User did not want to submit a Full Budget Disclosure then that step would be by-passed by clicking the ‘Continue’ button with the mouse pointer 10 on the Consumer Information screen FIG. 52.

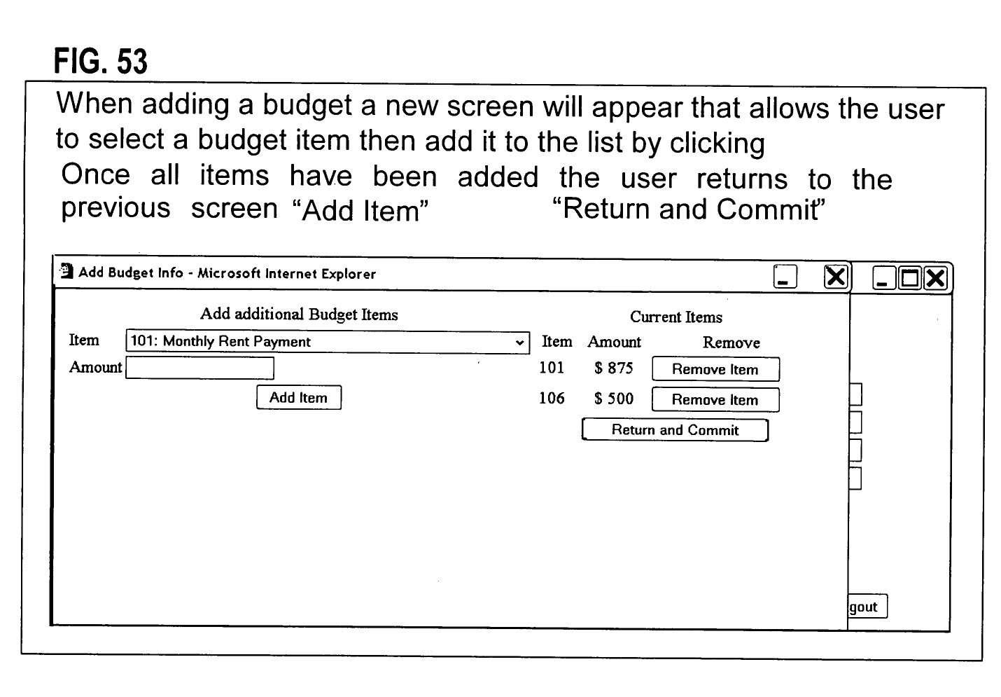

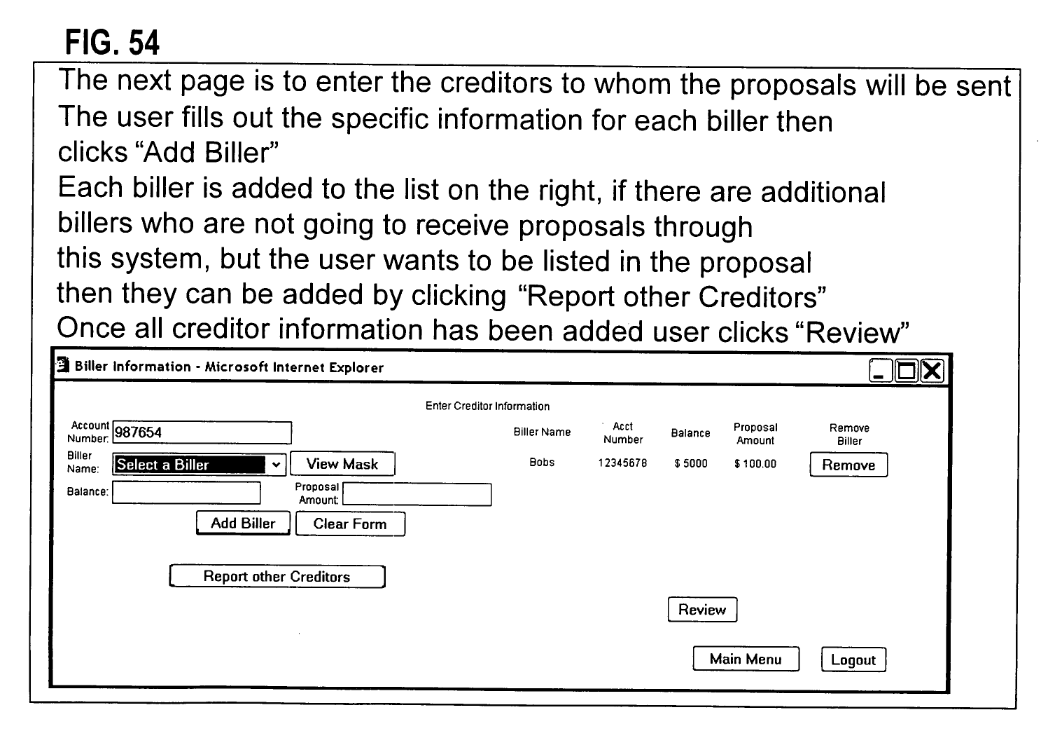

After the User clicks the ‘Return and Commit’ button the next screen to appear is the Biller Information screen FIG. 54. From this screen the User selects the Biller/Creditors that the Debt Management Proposal is being sent too. Depending on the number of accounts the Consumer has will determine the number of Debt Management Proposals that will be sent. If the consumer is putting just one account on a Debt Management Plan then just one will be sent. If the consumer has fifteen different accounts, then a total of fifteen Debt Management Plans will be sent. The System 1 will automatically append the Consumer Information FIG. 52 and the Full Budget Disclosure FIG. 53 information to each Biller/Creditor Debt Management Proposal being sent. On the Biller Information screen FIG. 54 the User will data enter the following information:

Account Number

Biller Name

Balance

Proposal Amount

To ensure the accuracy of the account number the User can click the ‘View Mask’ button to view a list of qualifying account numbers. The Biller/Creditor provides a listing of Pre-fixes or Suffixes that account number adheres to. As each Biller/Creditor is added they will be added to a running list of the right-hand side of the screen until all the Biller/Creditors have been added.

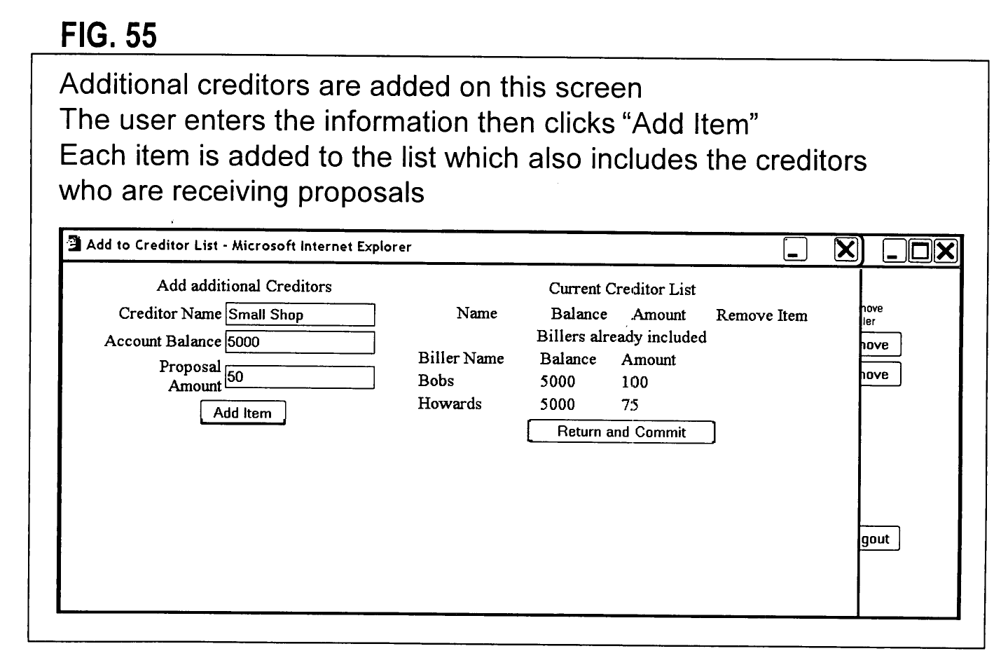

The User can select to append a Full Budget Creditor to the Debt Management Plan by clicking the ‘Add Full Budget Creditors’ button with the mouse pointer 10. The Full Budget Creditor is a listing of Biller/Creditors that will receive a Debt Management Proposal for this particular consumer. If a Full Budget Creditor is not desired then just the total number of creditors and the total outstanding debt will be reflected on the Debt Management Proposal as illustrated in FIG. 52 with no indication of who the additional creditors are and what is the amount owned to each. After clicking on the ‘Add Full Budget Creditors’ button with the mouse pointer 10 the Add FBCs screen FIG. 55 will appear. The User data enters the following information and a running list of items will appear on the right-hand side of the screen:

Creditor Name

Account Balance

Proposal Amount

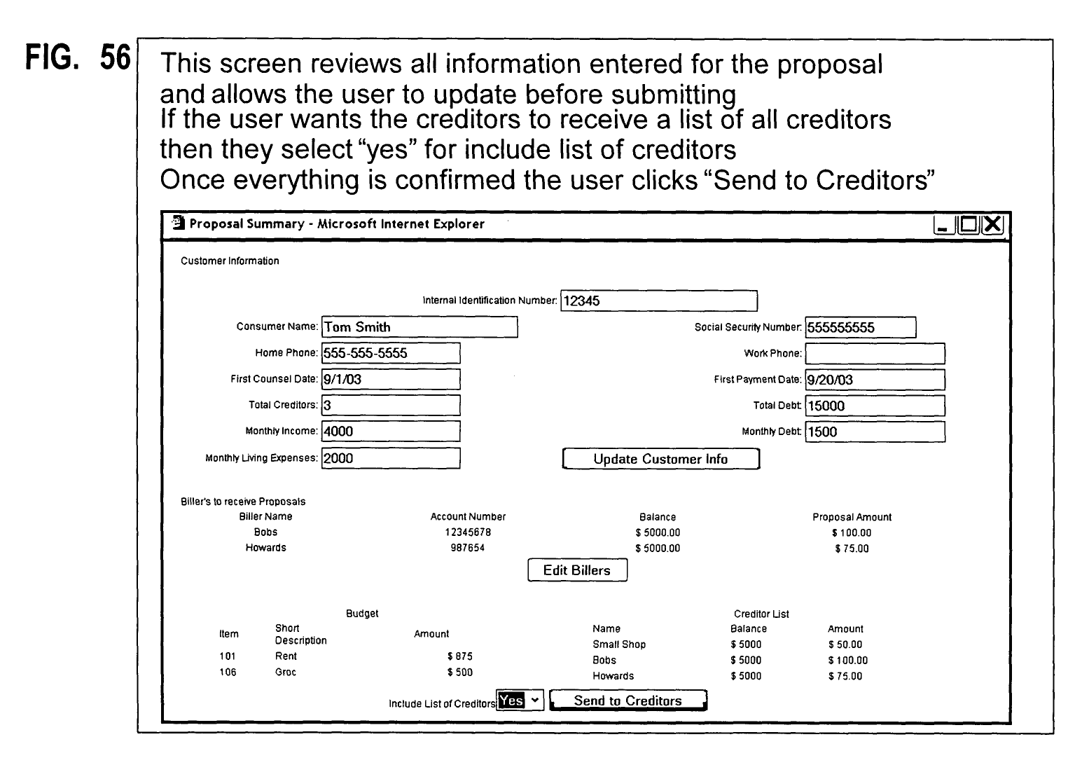

As the User enters additional items the ‘Add Item’ button is clicked using the mouse pointer 10 to go to the next item. After items have been added the User clicks the ‘Return and Commit’ button. The information has now been data entered, and the next screen to appear is the Proposal Summary Screen FIG. 56. This screens provides the User with the opportunity to review and edit the consumer information, Biller/Creditors to receive proposals, Full Budget Disclosure and Full Budget Creditor if information. To edit the consumer information the User would click the ‘Update Customer Info’ button. To edit the Biller/Creditors to receive Proposals listing the User would click the ‘Edit Biller’ button. To send the Full Budget Creditor with the Debt Management Proposal the Yes/No drop-down box would be selected. To submit the Debt Management Proposal the User would click the ‘Send to Creditors’ button.

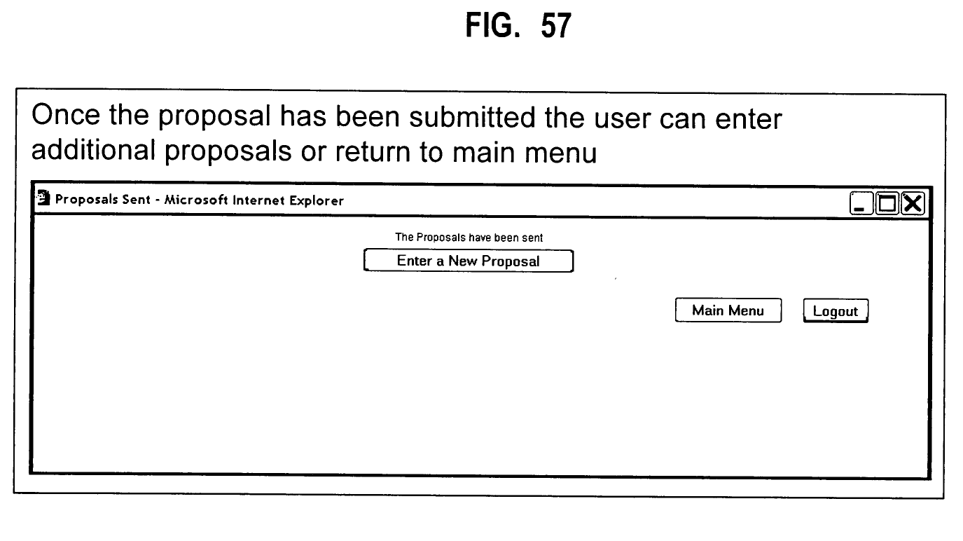

After clicking the ‘Send to Creditors’ button the Proposals Sent FIG. 57 screen would appear. If desired the User can choose to enter a new proposal by clicking on the ‘Enter a New Proposal’ button, the Consumer Information screen FIG. 52 would then appear. By clicking the ‘Main Menu’ button the Main Menu screen FIG. 51 would appear and the User can select a different option such as ‘Request a Balance Verification’. Alternatively, the User can select to logout of the system by clicking the ‘Logout’ button.

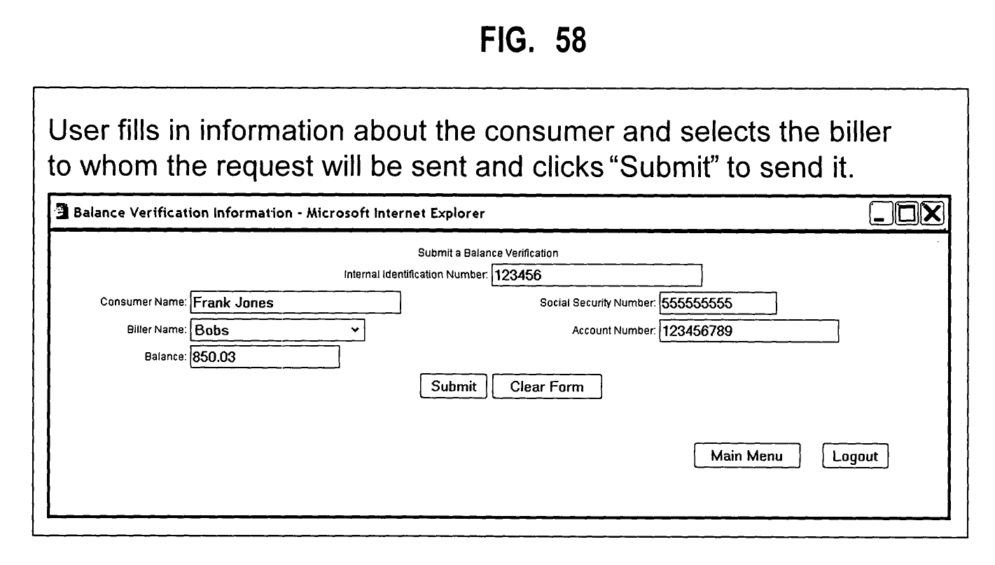

From the Main Menu FIG. 51 the User clicks the ‘Request a Balance Verification’ button and the Consumer Information screen FIG. 58 will appear. The User data enters the following information on the screen:

Internal Identification Number

Consumer Name

Biller Name

Balance

Social Security Number

Account Number

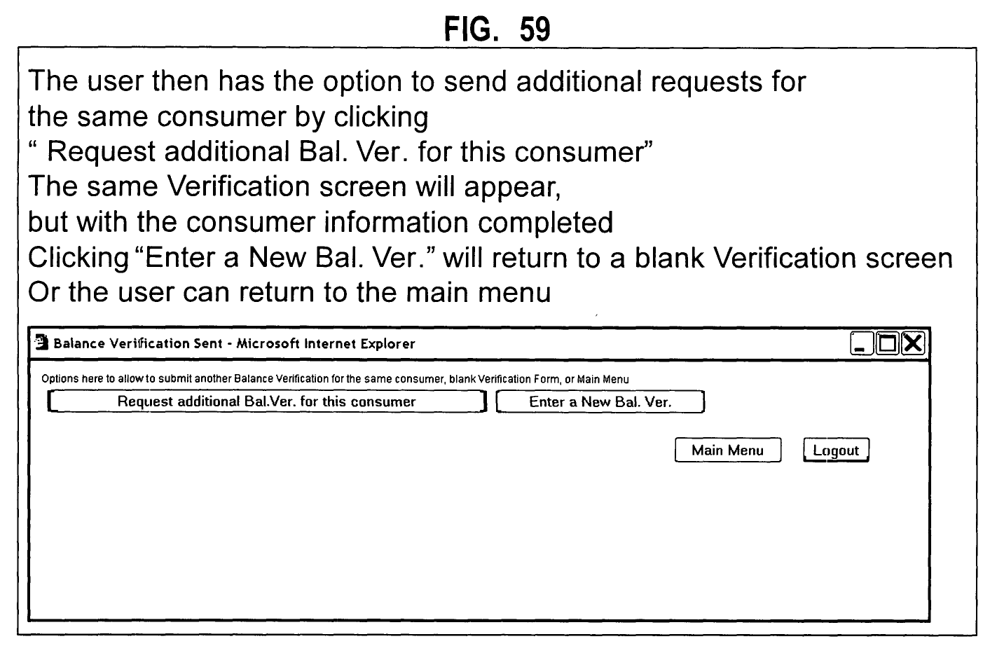

The User then clicks the ‘Submit’ button and the Balance Verification Sent screen FIG. 59 will appear. The User has four options on this screen:

Request additional Balance Verification for this consumer

Enter a New Balance Verification for different consumer

Main Menu

Logout

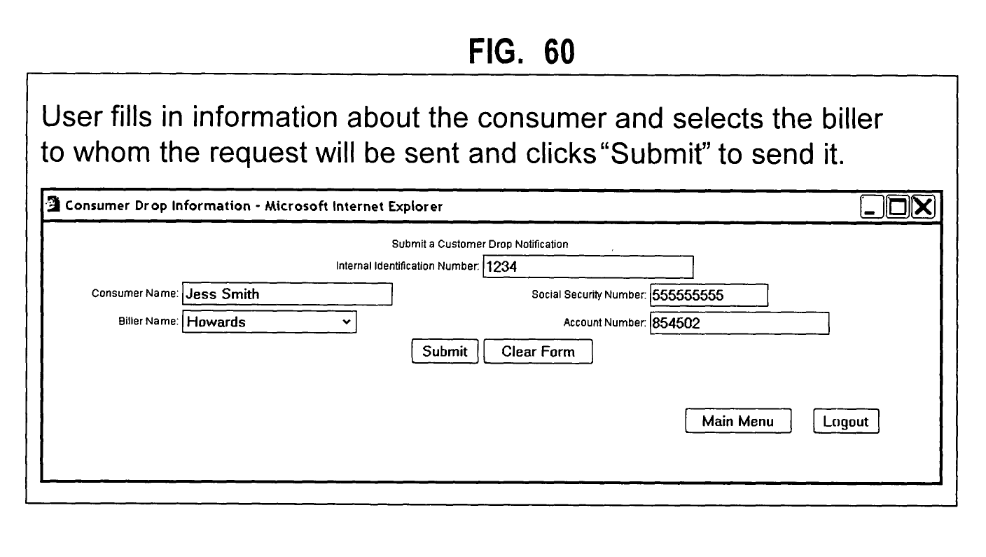

If the User selects ‘Request additional Balance Verification’ then the Consumer Information screen FIG. 60 will appear with the Biller Name field, Account Number field, and Balance field being blank. The new information is data entered by the User and the ‘Submit’ button is clicked. The Balance Verification Sent Screen FIG. 59 will appear and the process can be repeated until the User has sent the desired Balance Verifications for that consumer. The User can select to enter a new balance verification for a different consumer by selecting the ‘Enter a New Balance Verification’ button and the Consumer Information screen FIG. 58 will appear with blank fields.

The User may logout of the system by clicking the ‘Logout’ button or return to the Main Menu FIG. 51 by clicking the ‘Main Menu’ button. From the Main Menu FIG. 51 the User can submit a consumer Drop by selecting ‘Drop a Consumer from the program’. The Consumer Information screen FIG. 52 will appear and the User enters the following information into the fields provided:

Internal Identification Number

Consumer Name

Biller Name

Social Security Number

Account Number

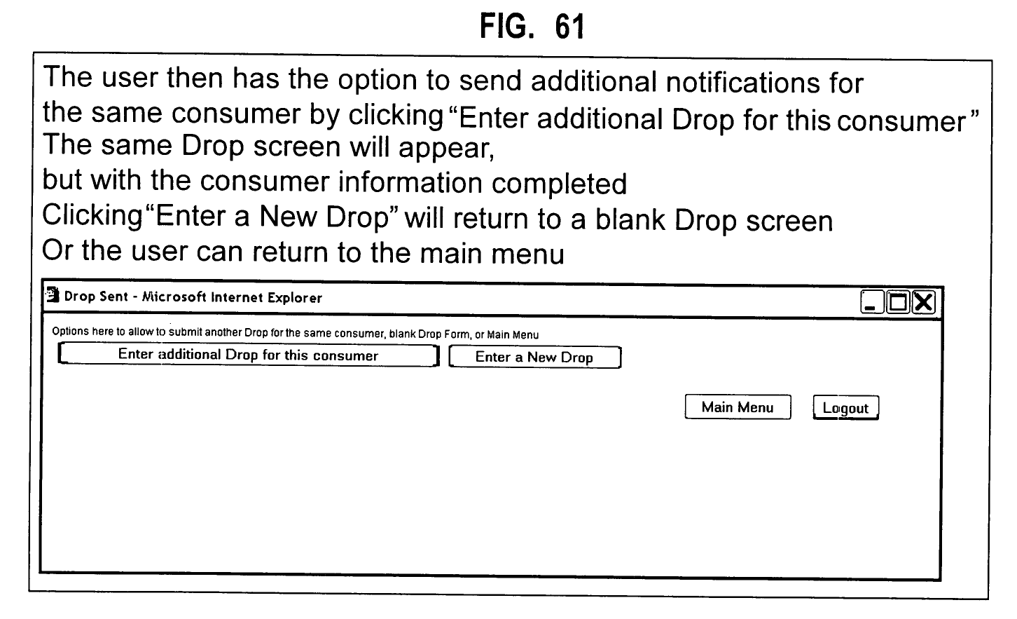

The User clicks the ‘Submit’ button and the Consumer Drop FIG. 61 screen will appear notifying the User that the Drop was sent to the Biller/Creditor. Additional Consumer Drops can be sent to different Biller/Creditors for the same consumer by clicking the ‘Enter additional Drops for this consumer’ button. If selected the Consumer Information FIG. 52 will appear with the Biller Name and Account Number fields blank. This process can be repeated until the User has sent out the Drop notifications to appropriate Biller/Creditors.

From the Consumer Drop screen FIG. 61 the User has the option of entering a new Consumer Drop on a different consumer, logging out of the system or returning to the Main Menu FIG. 51.

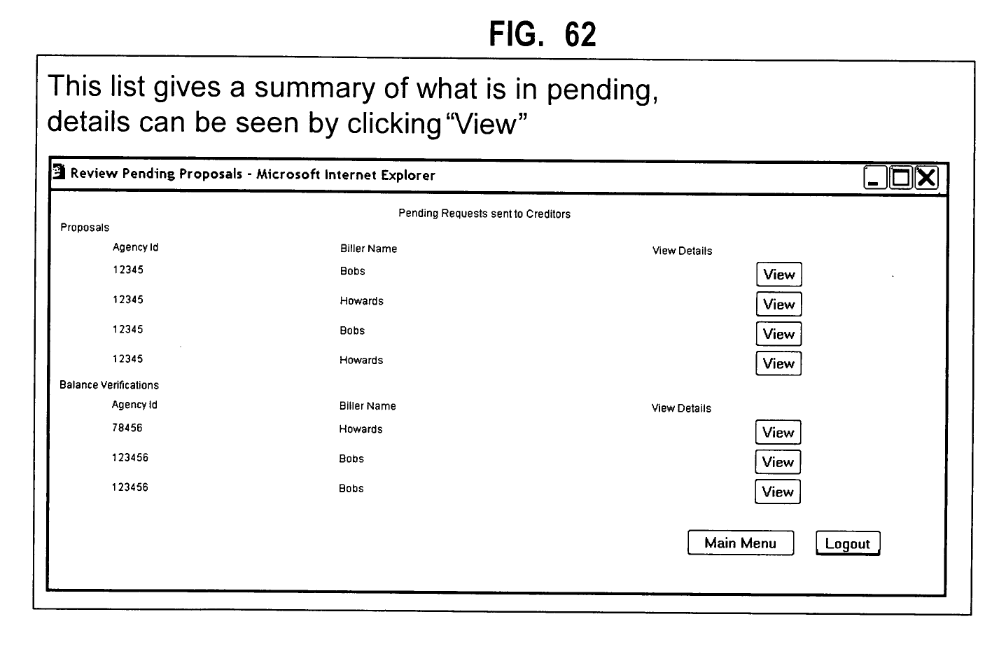

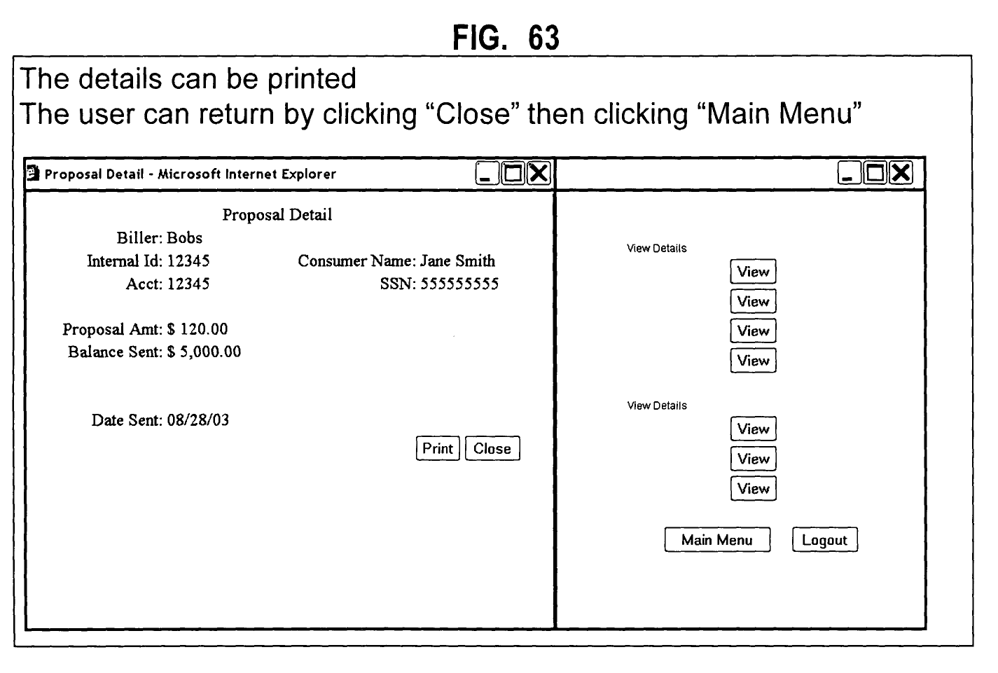

To view ‘Returned’ or ‘Pending’ Debt Management Proposals or Balance Verifications the User would click the ‘Returned’ or ‘Pending’ buttons from the Menu Main FIG. 51. The User can specify whether to view ‘Returned’ or ‘Pending’ by selecting the appropriate button. If the ‘Pending’ button is selected the Review Pending Proposals screen FIG. 62 will appear. Proposals and balance verifications that have not been processed by the individual Biller/Creditors will be shown. A ‘View’ button will appear on the right-hand side of each item. Selecting the ‘View’ button next to an item will open the Proposal Detail screen FIG. 63 showing high-level details about the proposal or balance verification, and the date sent to the Biller/Creditor for processing. A print version of the detail record is available by clicking the ‘Print’ button. Pressing the ‘Close’ button will return the User to the Main Menu FIG. 51.

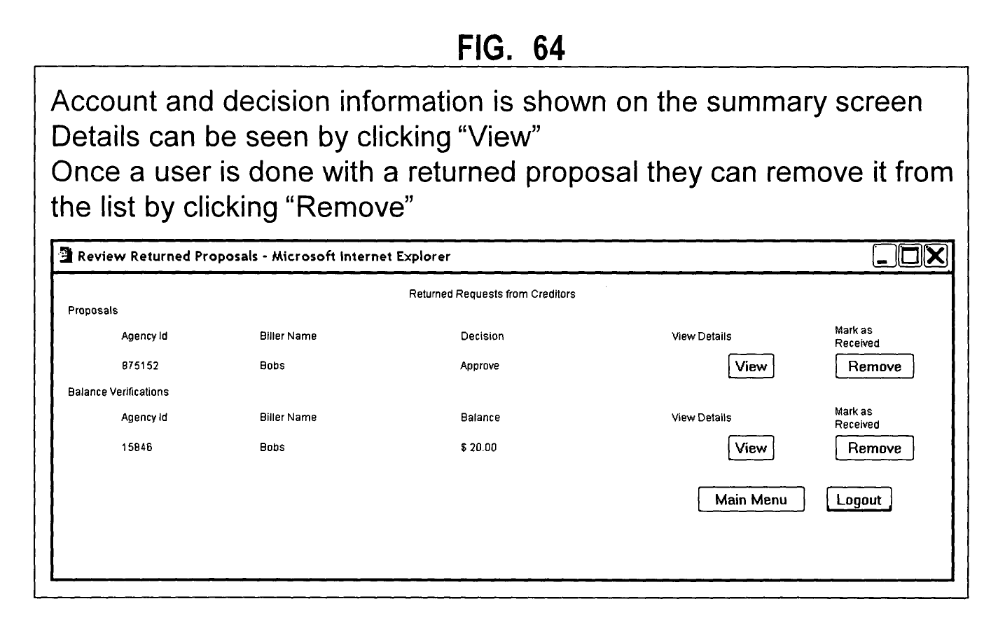

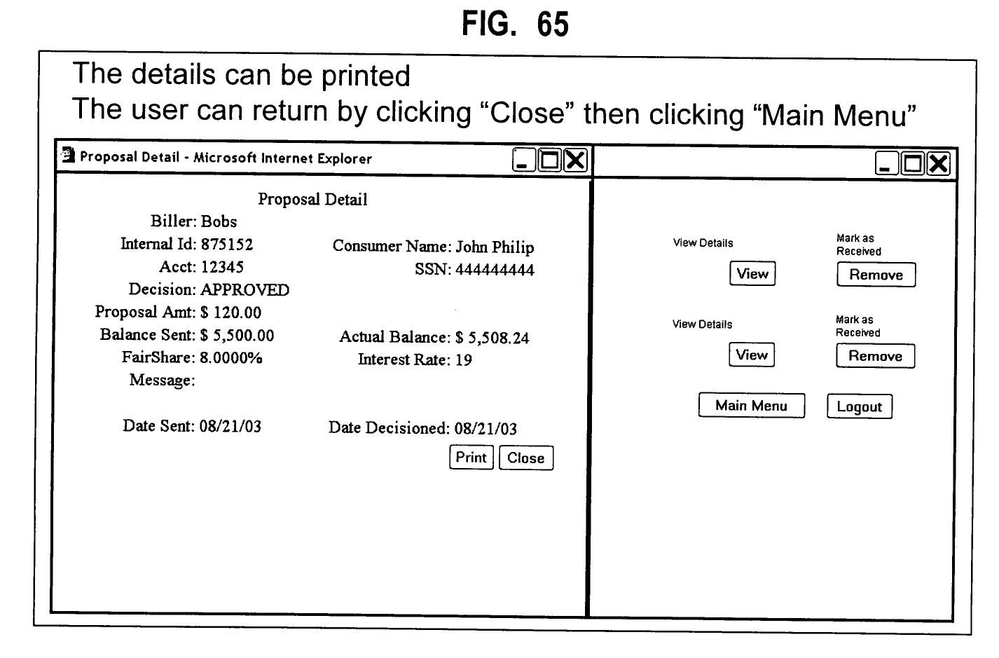

If the ‘Returned’ button is selected the Review Returned Proposals screen FIG. 64 will appear. Proposals and balance verifications that have been processed by the individual Biller/Creditors will be shown. A ‘View’ button next to an item will open the Proposal Detail screen FIG. 65 showing high-level details about the proposal or balance verification. The Biller/Creditor decision (Approved/Rejected) is displayed in addition to the date sent and date processed. Items are removed from the list by the User clicking the ‘Remove’ button next to each item.

Turning now to the creditor computer 38, and its role in interfacing, receiving, and processing electronic debt management proposals (DMPs). Computer 38 also handles other related requests from an originator, concentrator, or Bill Service Provider of such requests and presenting with a Graphical User Interface (GUI) 61 using a secure, online computer network such as the Internet 14 or other similar direct access to an institution or organization that has a vested interest, extents credit, processes payments or performs collection activity on pass-due accounts.

From the Creditor Computer 38 processing commences as follows.

Open Internet Explorer 48

Type URL Address

Press ‘Enter’

Login Screen 62 FIG. 11 will appear, the size will occupy ⅓ of the available monitor 42 space so that the creditor's internal application can be open simultaneously, to view and record information from one application to the other without toggling. Enter User ID and Password as illustrated in FIG. 12 and press the ‘Login’ button. An Authentication routine 63 will run and authenticate the User and User Permissions such as access to reports and identify the User as a batch or individual processor.

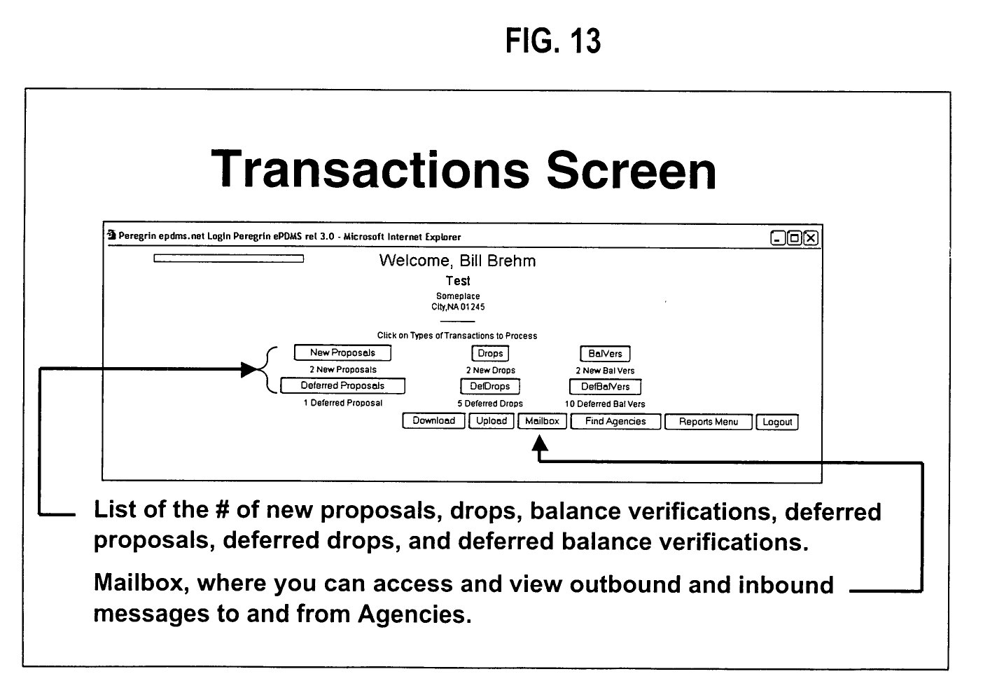

If the User ID cannot be authenticated a message will appear “User ID or Password incorrect, please try again”. After three-failed authentication attempts the User ID will be locked out of the system. If the User ID is authenticated, the Transactions Screen (Main Menu) 64 FIG. 13 will next appear indicating the following:

Number of new proposals to decision.

Number of deferred proposals to decision.

Number of new drops to process.

Number of deferred drops to process.

Number of new balance verifications to process.

Number of deferred balance verifications to process.

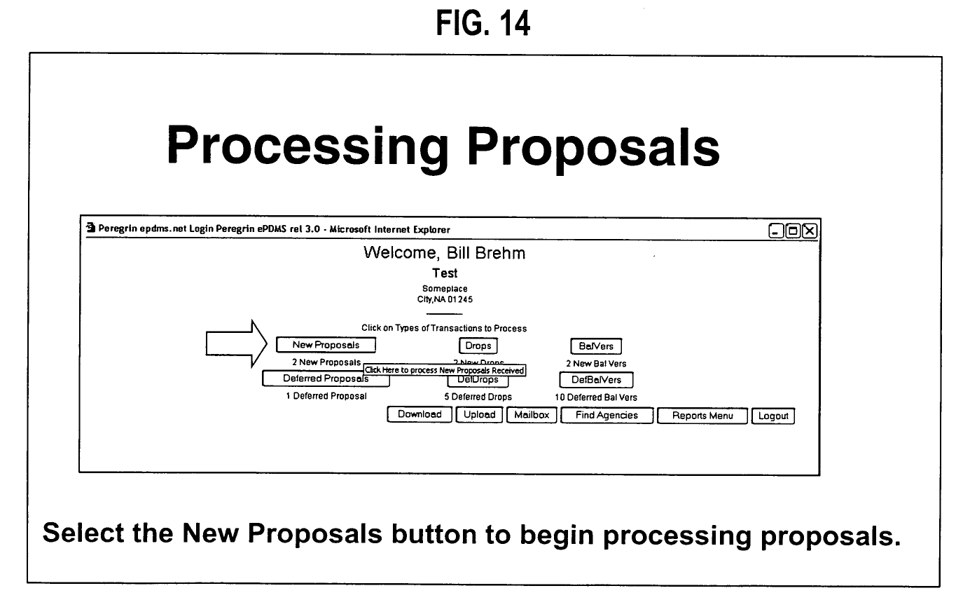

Additionally, the User can access their mailbox 67, search for an agency (originator) 75 or view reports 74. To process new proposals the User would merely press the New Proposals button as illustrated on FIG. 14 using their mouse 46 and perform a similar action for the desired functions available.

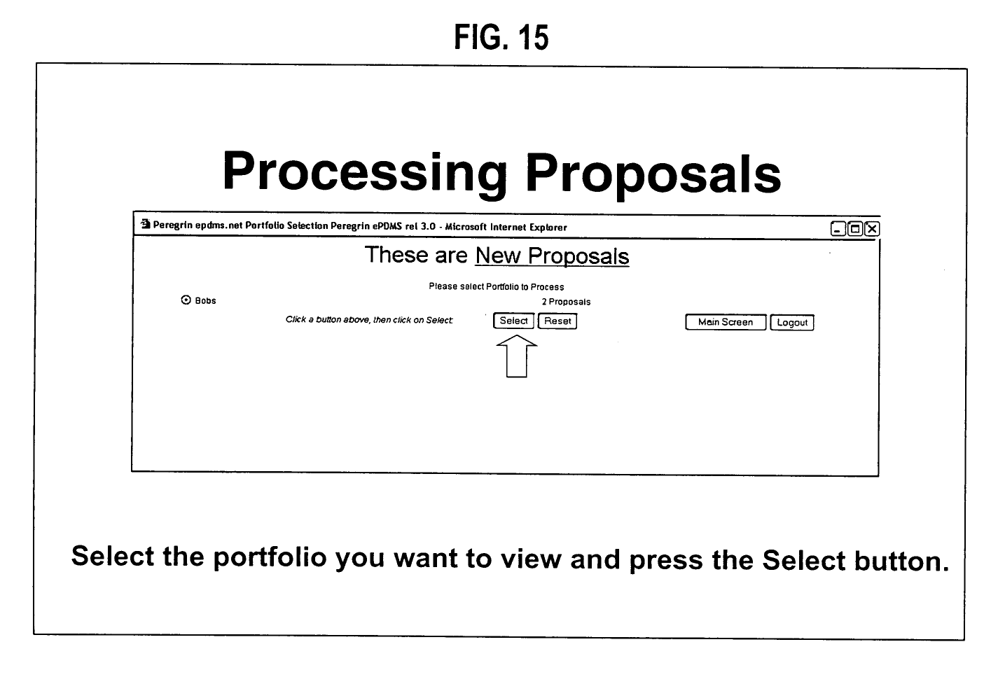

Once the New Proposal button has been pushed a Processing Proposals screen FIG. 15 will appear indicating the number of proposals for each creditor portfolio. Each portfolio will have a radio button next to it and the cursor or focus will default to the first portfolio. If this is the desired portfolio to work then the User presses the Select button or the User can select any one of the portfolios shown.

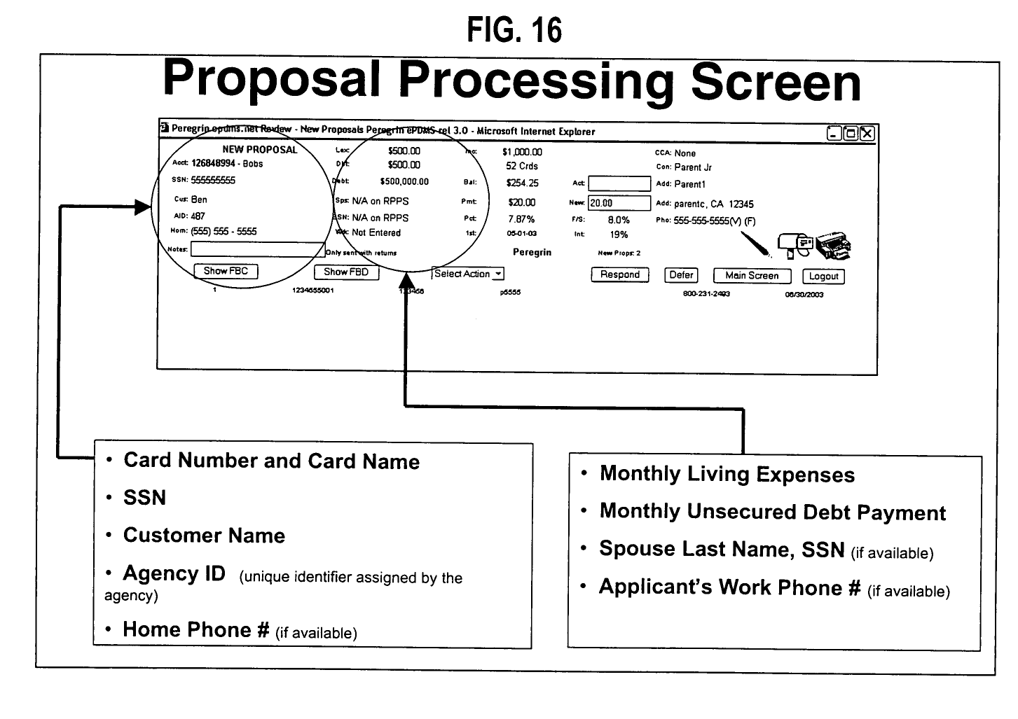

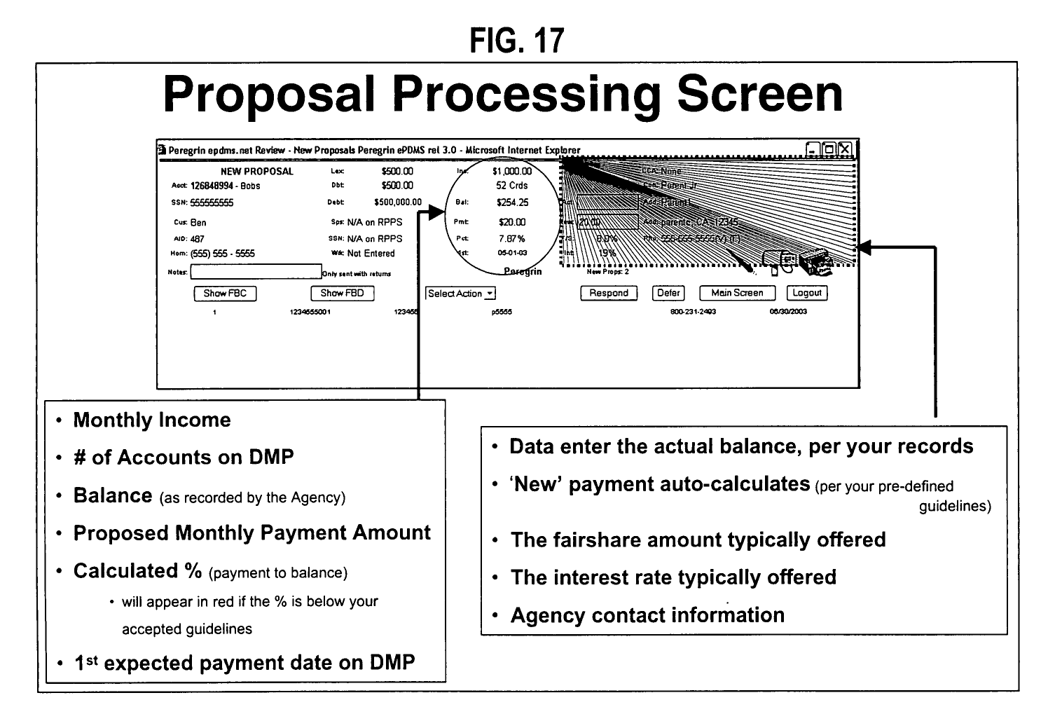

After pressing the select button the Proposal Processing Screen FIG. 16 and FIG. 17 will appear. The screens in FIG. 16 and FIG. 17 will indicate that this is a New Proposal and provide the following information:

Card or account number and card name.

Social Security Number of the consumer/customer.

Consumer/customer name.

Agency identification number.

Consumer/customer home phone number.

Consumer monthly living expenses.

Consumer monthly unsecured debt payment.

Spouse name.

Spouse Social Security Number.

Consumer/customer work phone number.

Consumer/customer monthly income.

Number of accounts on debt management plan.

Current balance as reported by agency.

Proposed monthly payment for this account

Payment calculated as percentage % to current balance.

Date of 1^{st} expected payment

Field to data enter the actual balance

Field that automatically calculates payment

The fairshare amount typically offered

Agency address information.

Agency phone number.

Agency fax number.

Agency contact person.

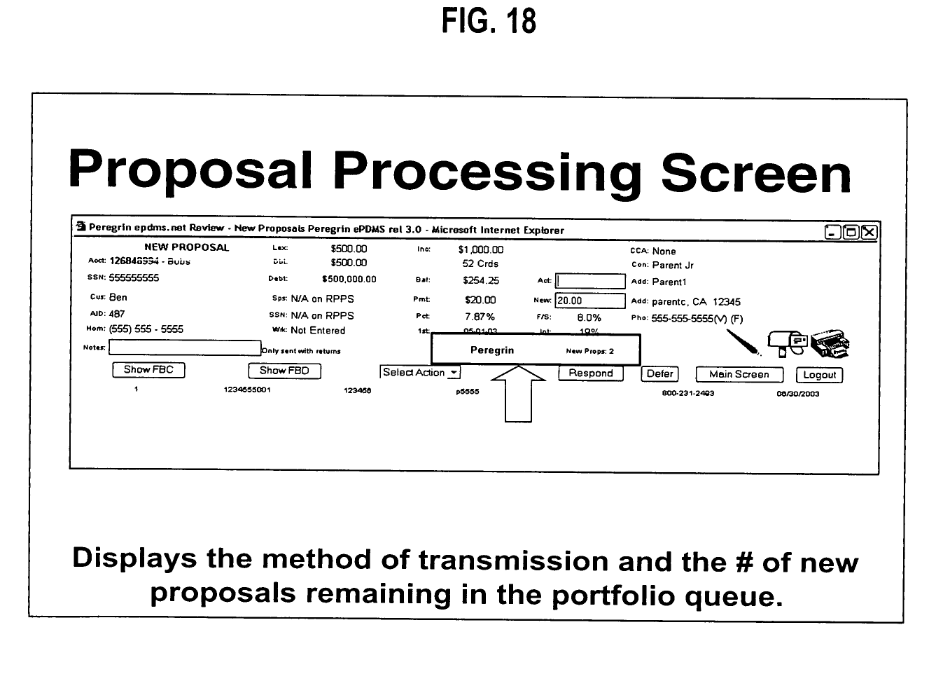

The method of transmission of the proposal and the number of new proposals remaining in the portfolio queue is indicated in FIG. 18, it would show either:

Intermediary computer 12 identity

MasterCard™

Visa™

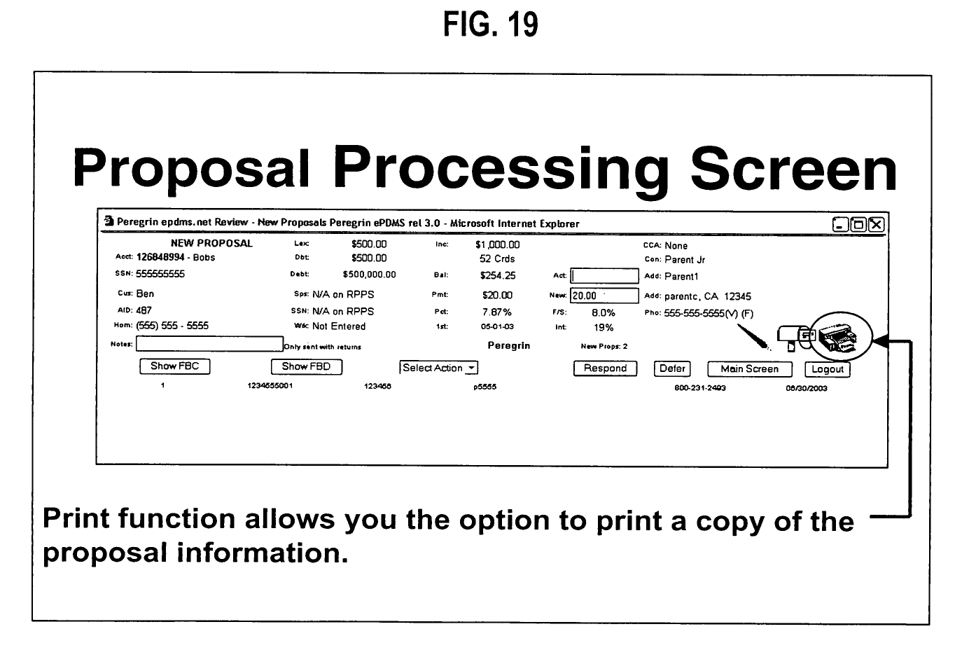

If a printed copy of the proposal information is desired, then a print feature 71 is available as illustrated in FIG. 19.

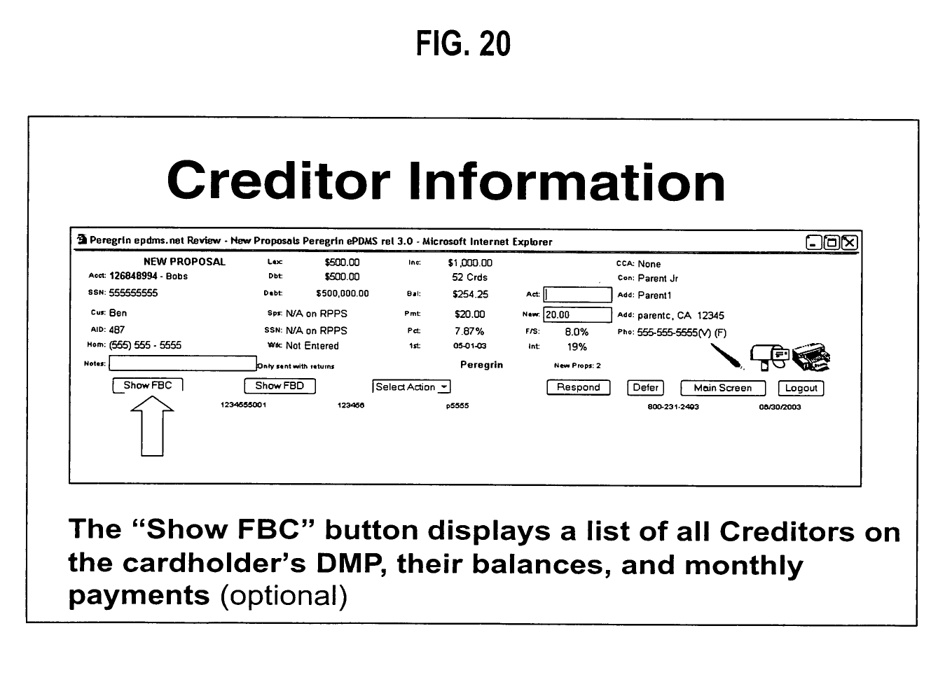

If the Full Budget Creditor 69 (FBC) was submitted with the original proposal it can be viewed by pressing the ‘Show FBC’ button as illustrated in FIG. 20. The FBC displays a list of Creditors on the cardholder's debt management plan, their balances, and monthly payments.

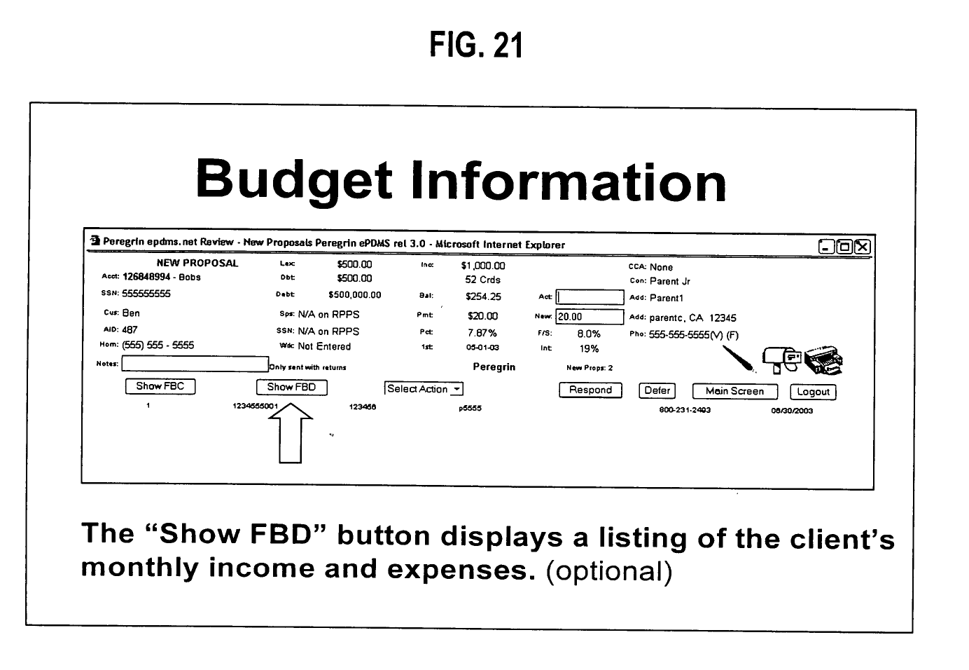

If the Full Budget Disclosure (FBD) 68 was submitted with the original proposal it can be viewed by pressing the ‘Show FBD’ button as illustrated in FIG. 21. The FBD displays a listing of the client's monthly income and expenses.

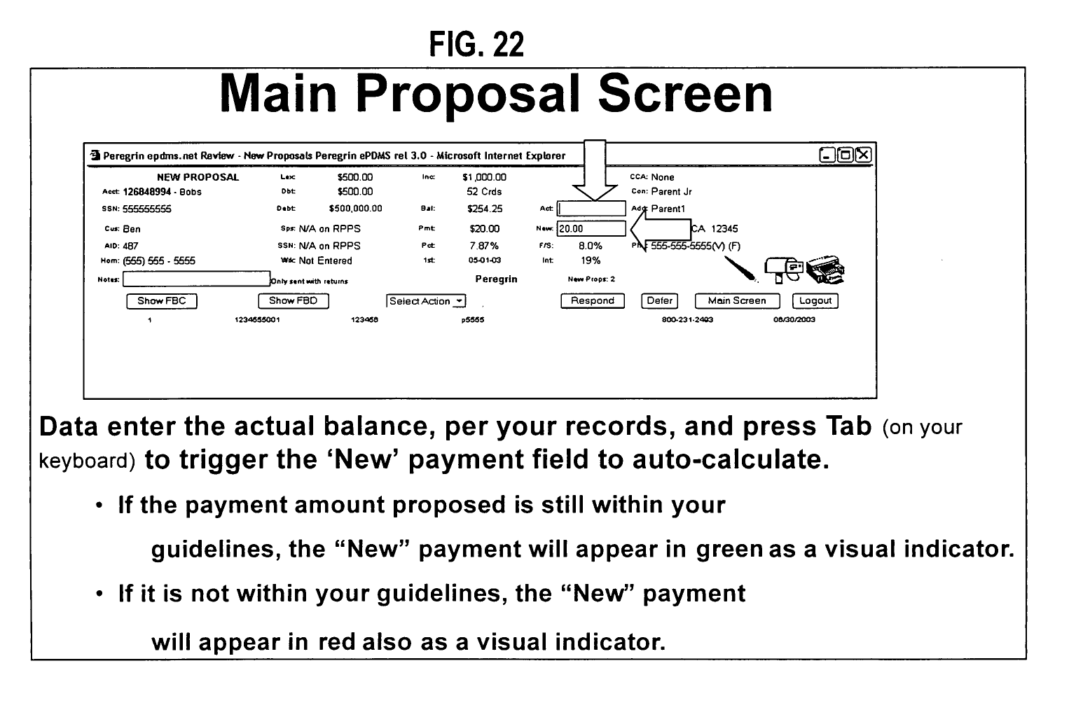

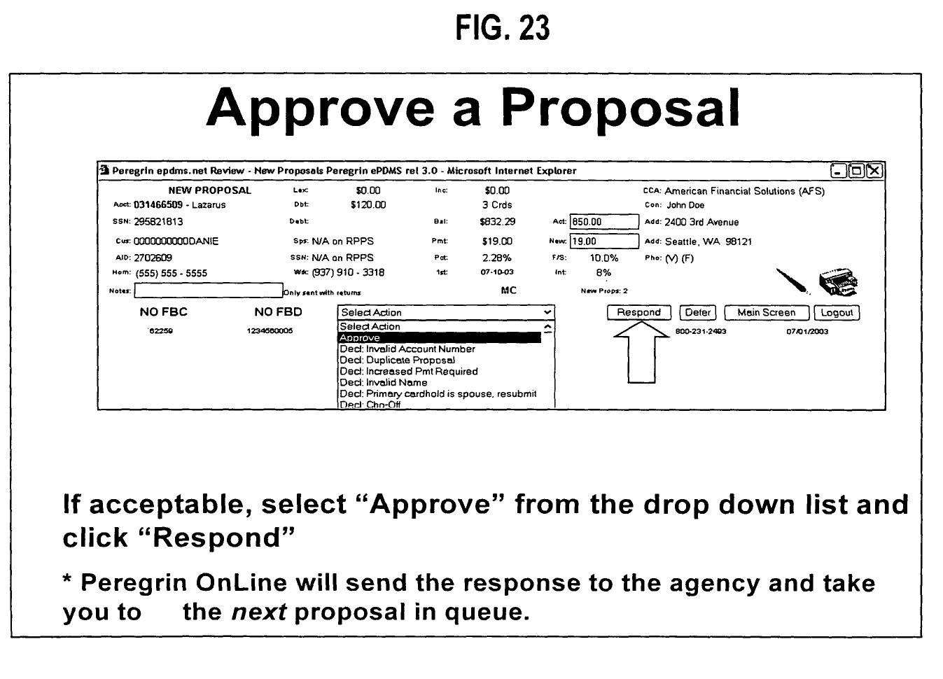

The User would now data enter the actual account balance as illustrated in FIG. 22. Based on the creditor payment guidelines the new payment field would automatically reflect the needed payment. If the payment amount proposed is still within the creditor guidelines, the ‘New’ payment will appear in green text as a visual indicator. If it is not within the creditor guidelines, the ‘New’ payment will appear in red also as a visual indicator. If the ‘New’ payment is acceptable, select ‘Approve’ from the Select Action drop down list and click ‘Respond’ as illustrated in FIG. 23.

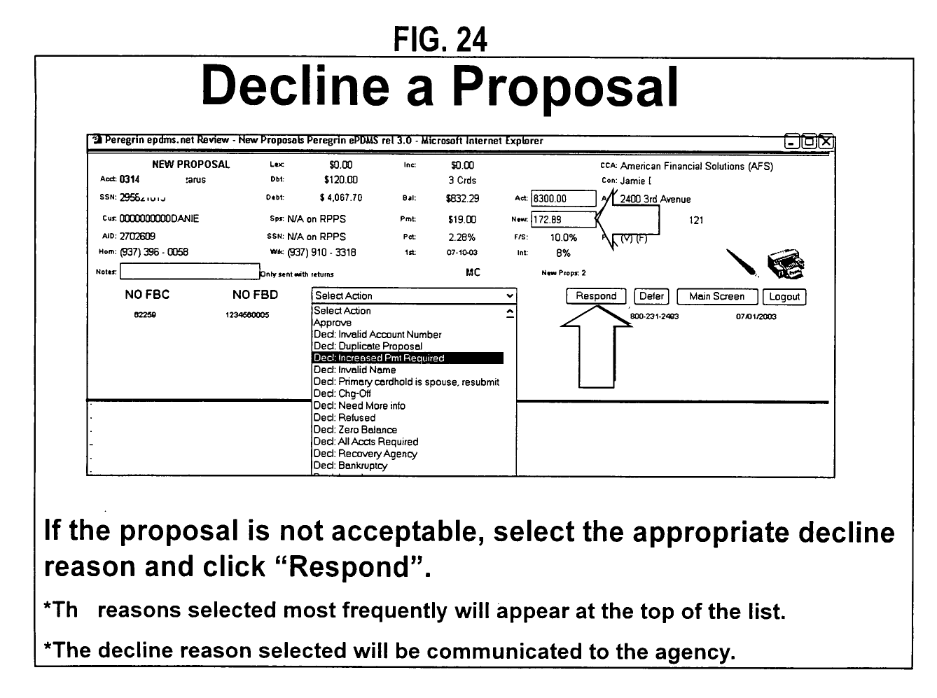

To decline a proposal, select the appropriate decline reason and click ‘Respond’ as illustrated in FIG. 24. The reasons selected most frequently will appear at the top of the list and the decline reason selected will be communicated to the originating agency.

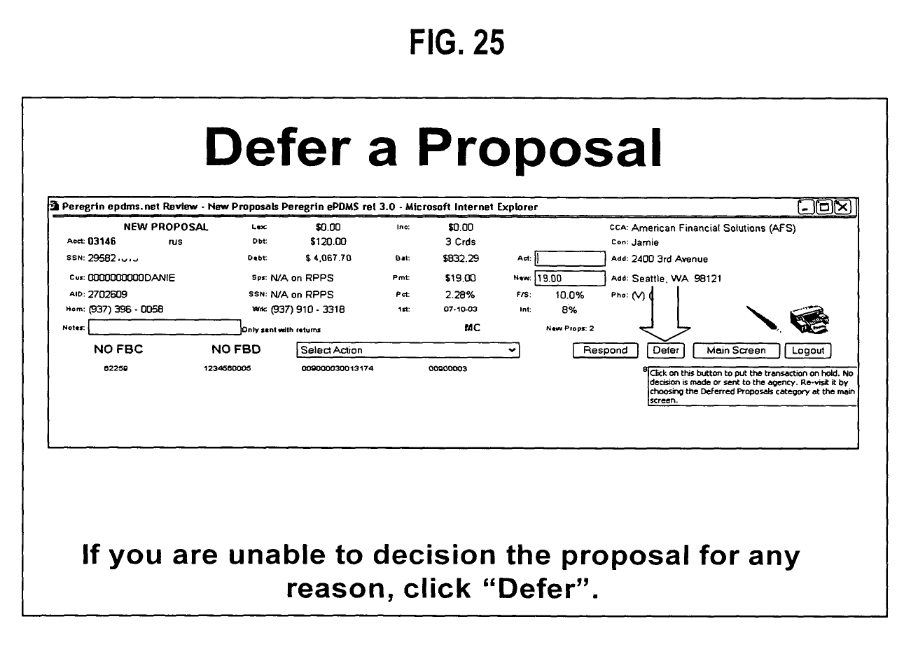

If the User is unable to decision the proposal for any reason, it can be deferred until a later date by clicking the ‘Defer’ button as illustrated in FIG. 25.

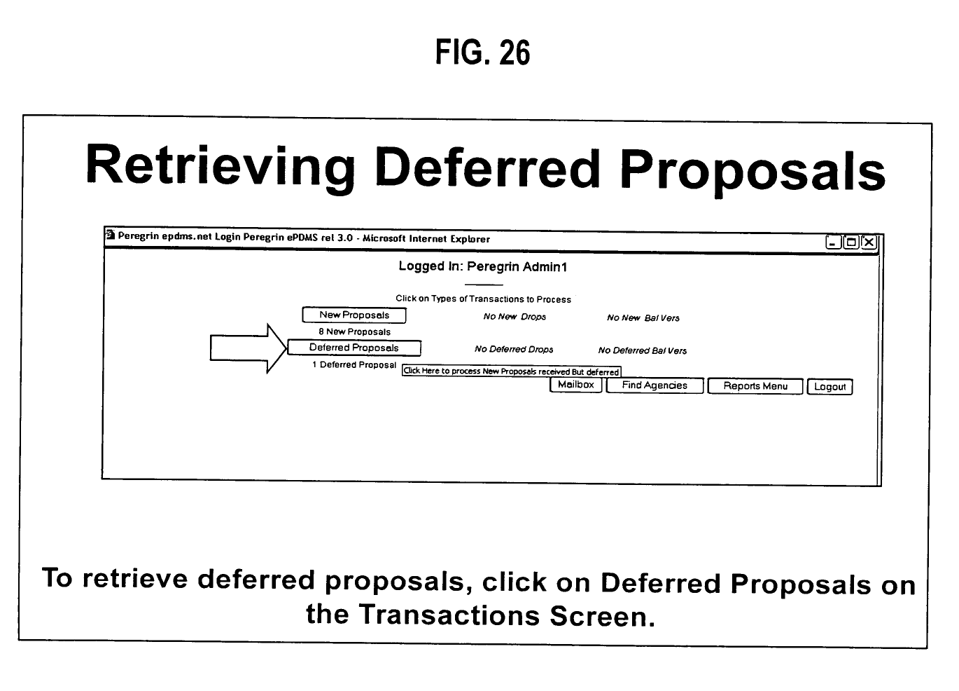

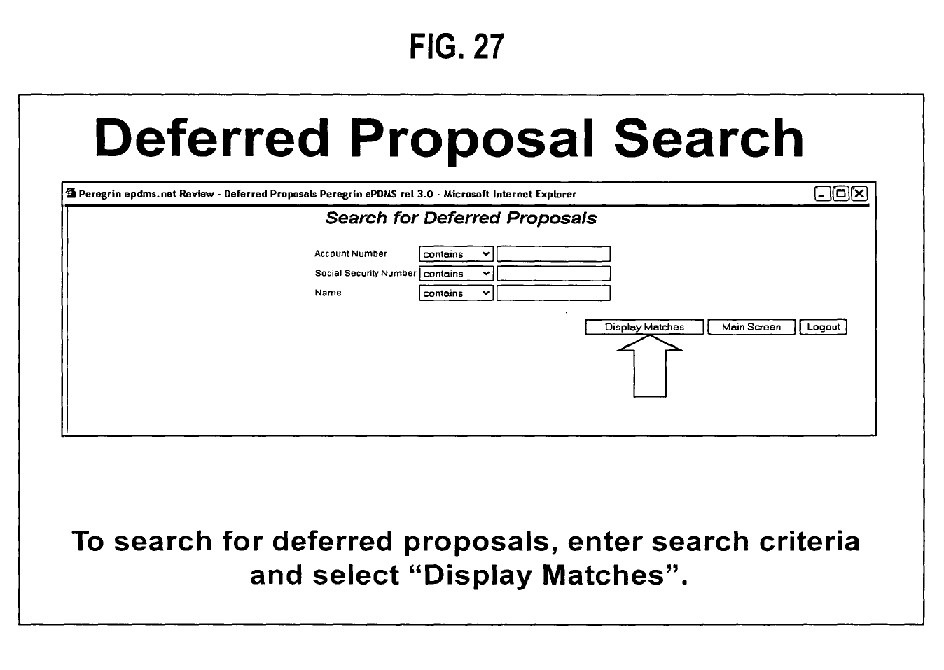

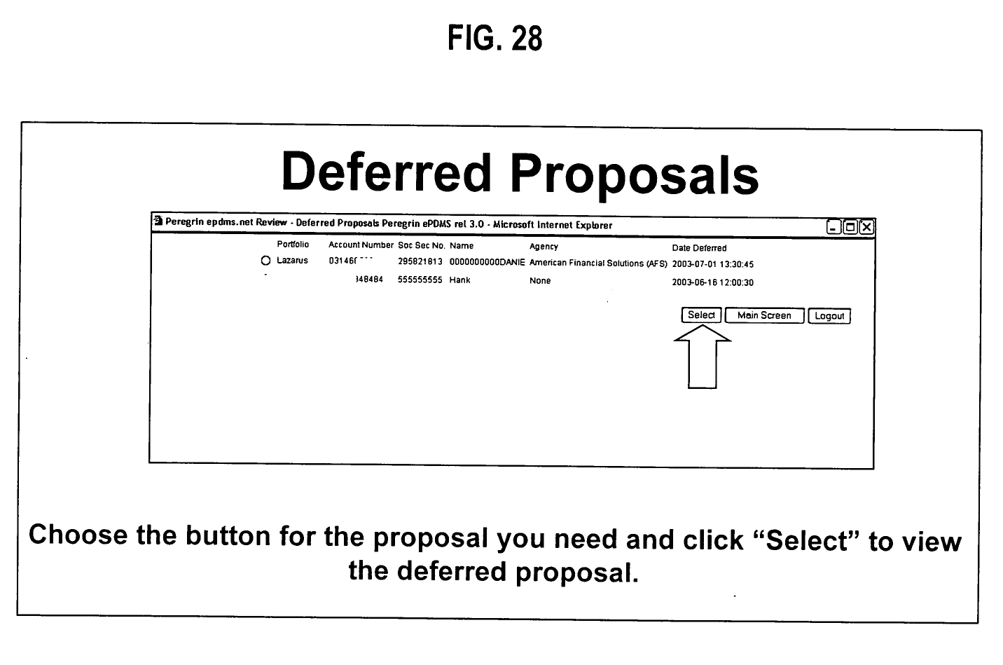

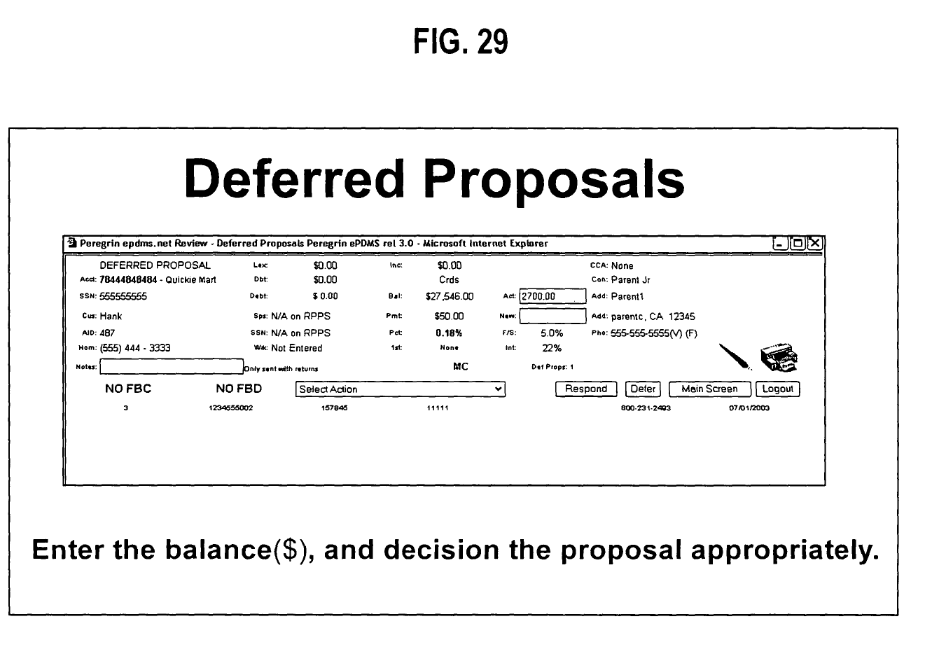

When it is desirable to retrieve a deferred proposal, click on Deferred Proposals on the Transactions Screen as illustrated in FIG. 26. The Search for Deferred Proposals Screen FIG. 27 will appear, search by Account Number, Social Security Number or Name and click the Display Matches. If no search criterion is entered, then all unprocessed deferred proposals will be returned. Choose the radio button for the proposal to be viewed and click ‘Select’ button to view the deferred proposal as illustrated in FIG. 28. The deferred proposal is now available to be decisioned appropriately as illustrated in FIG. 29.

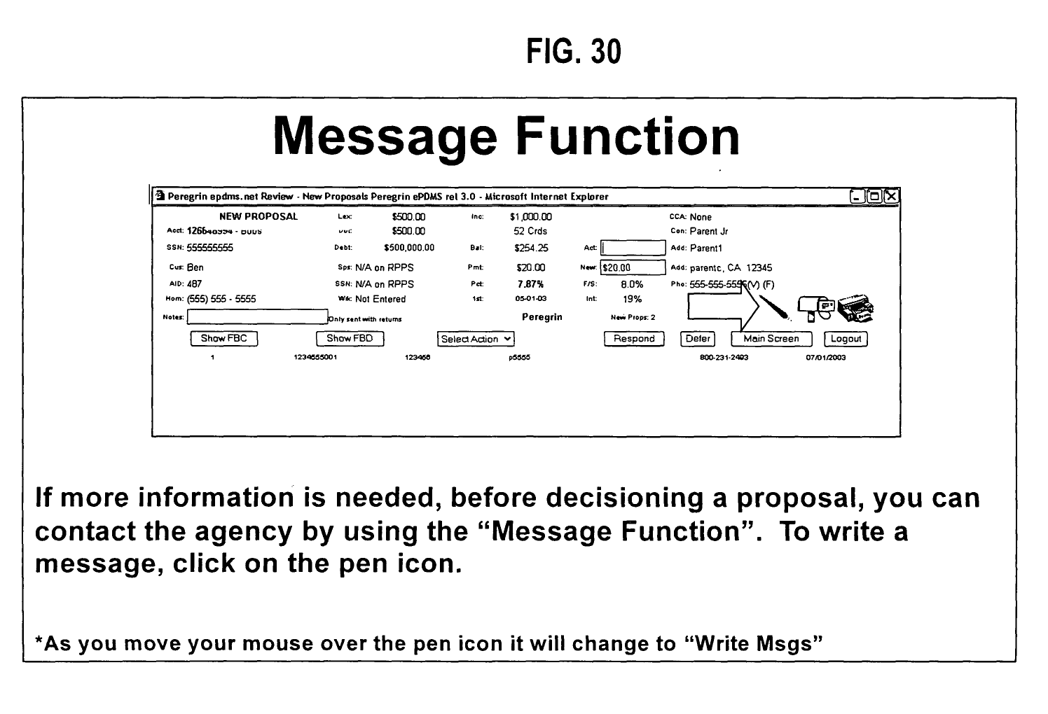

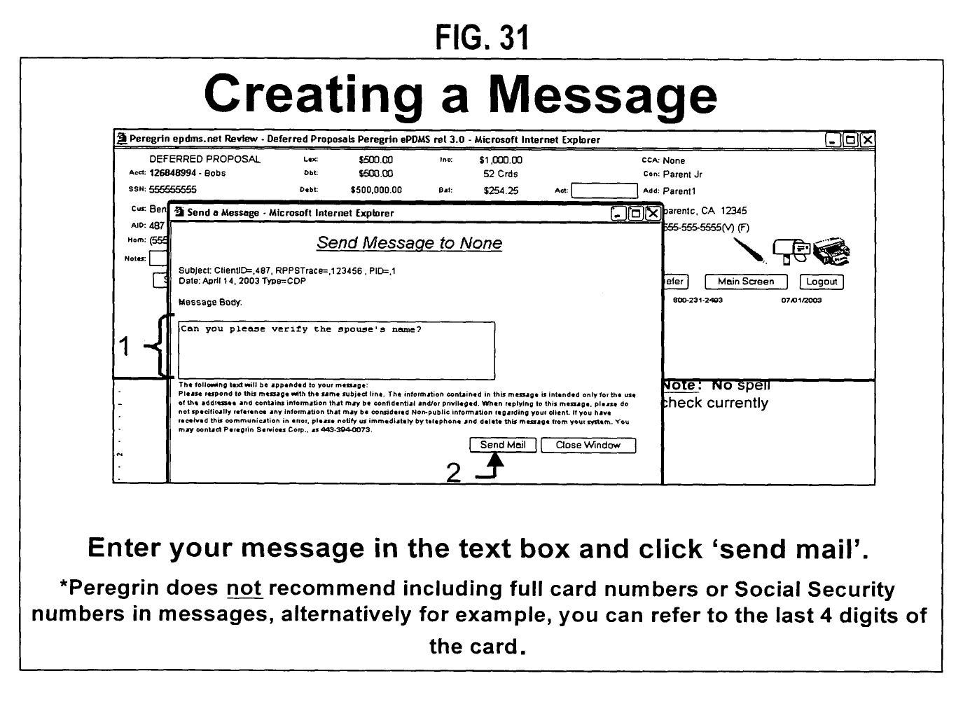

When the User needs additional information before making a decision on a proposal, the User can contact the originating agency by using the ‘Message Function’ by clicking on the ‘pen’ icon as illustrated in FIG. 30. Moving the mouse 46 pointer over the pen icon will cause it to change to ‘Write Msgs’. A text box will appear where the User enters the message and clicks the ‘Send Mail’ button to forward the message. The System 1 automatically inserts the following information to assist the originating agency in identifying the consumer as illustrated in FIG. 31:

Client ID Number

Proposal Trace Number

Today's date

Transaction Type

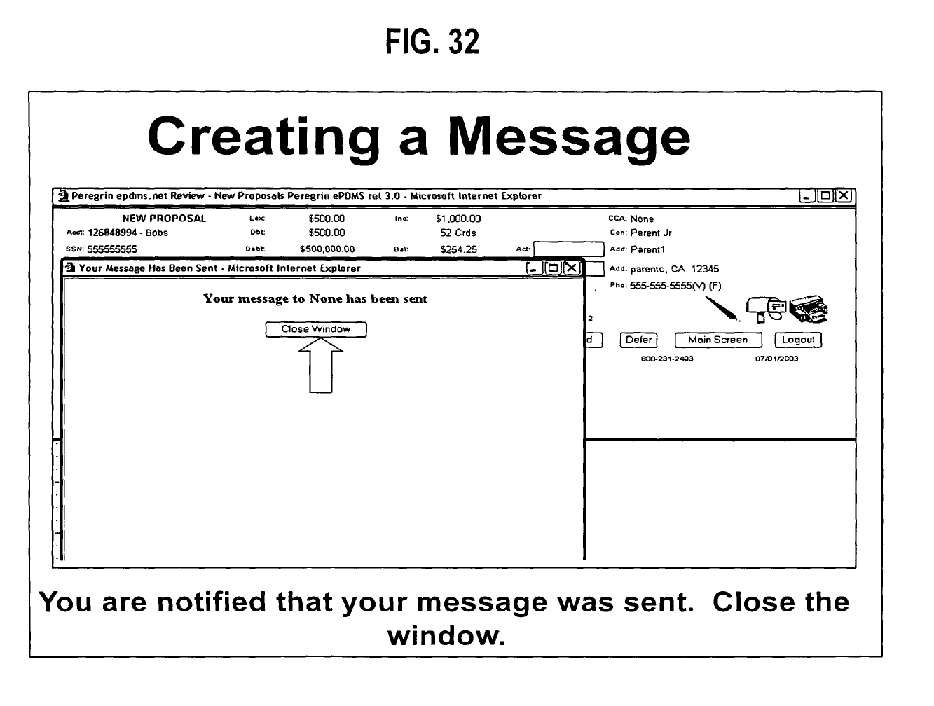

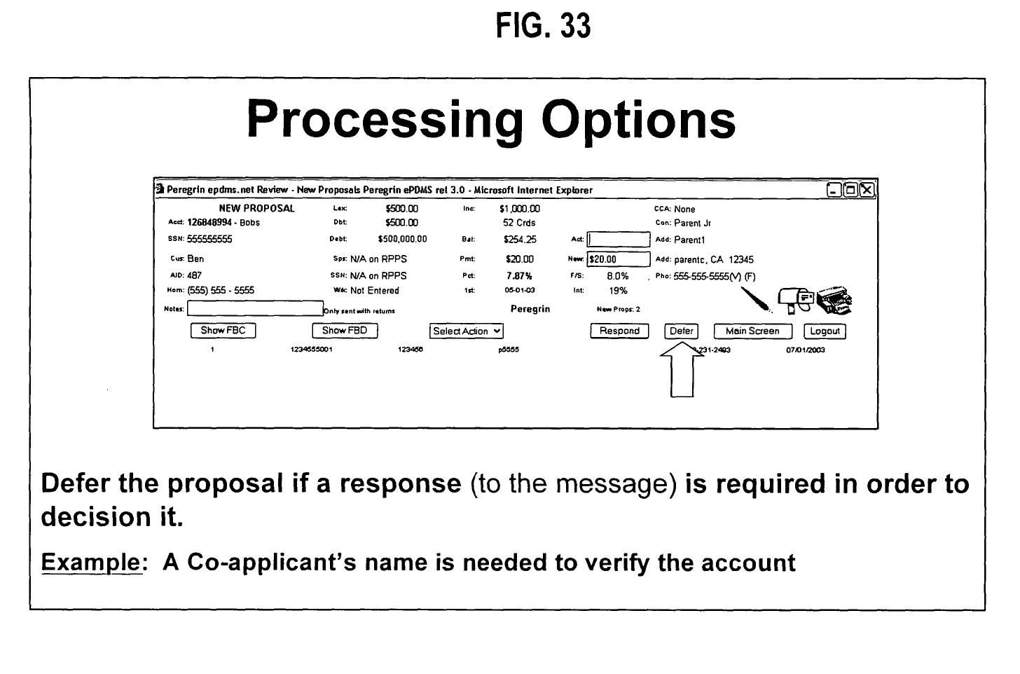

The User is then notified that the message was sent and can closeout that window/screen as illustrated in FIG. 32, which will take the User back to the Proposal Processing screen as illustrated in FIG. 33.

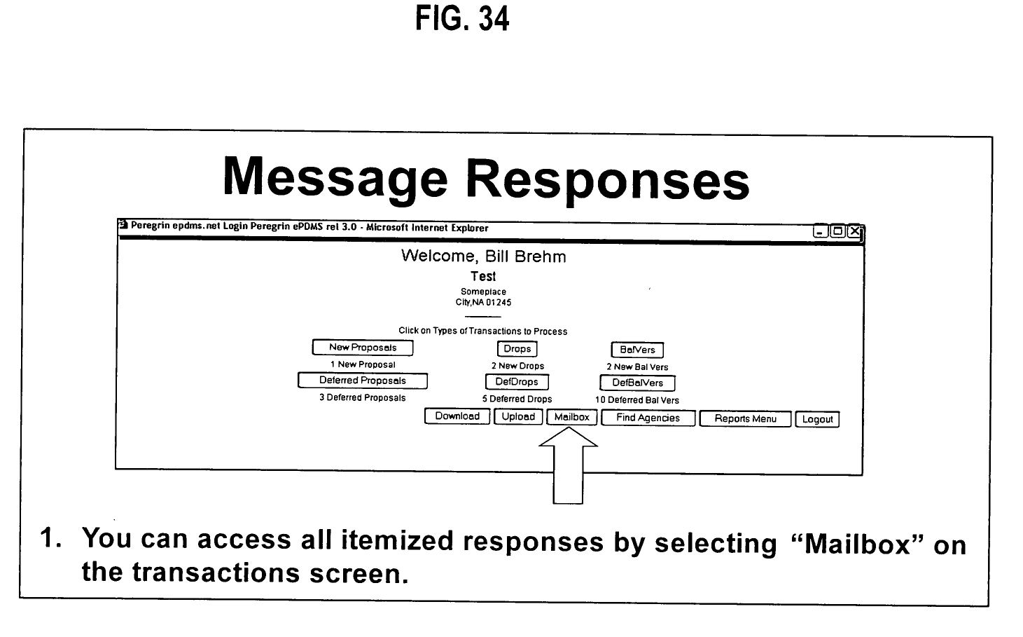

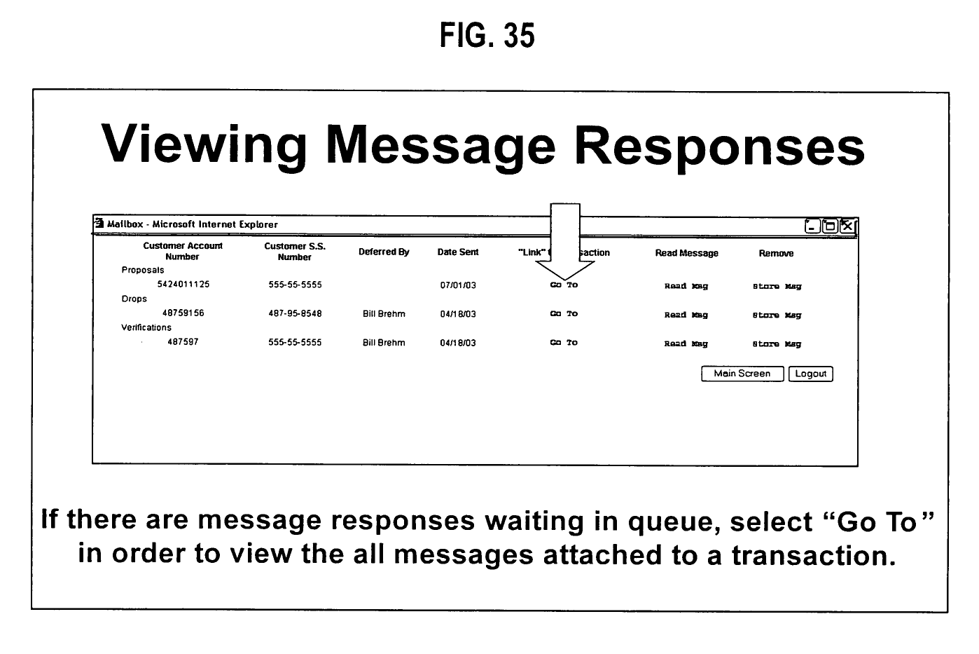

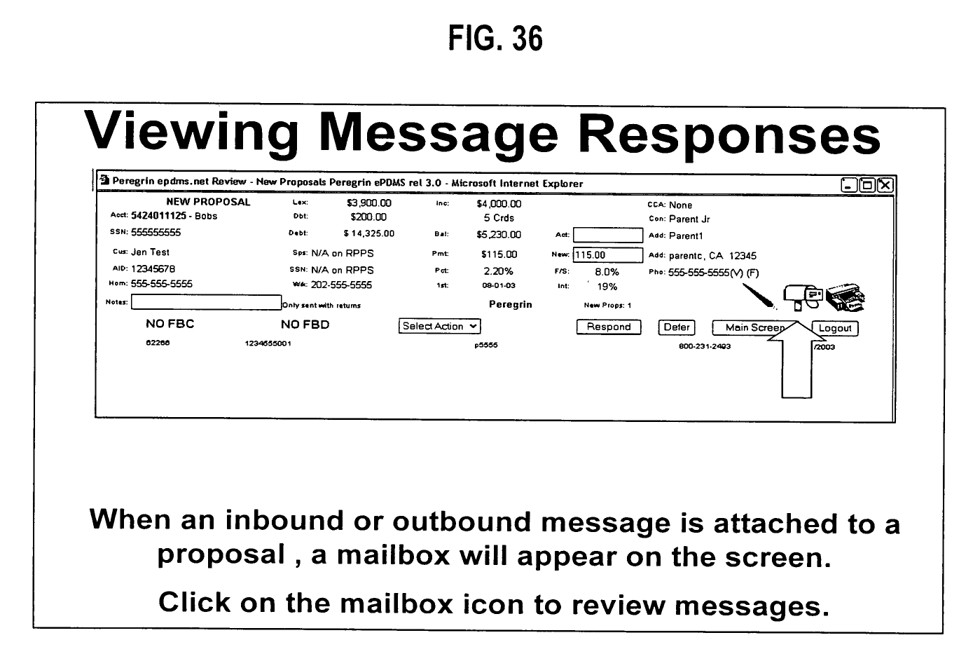

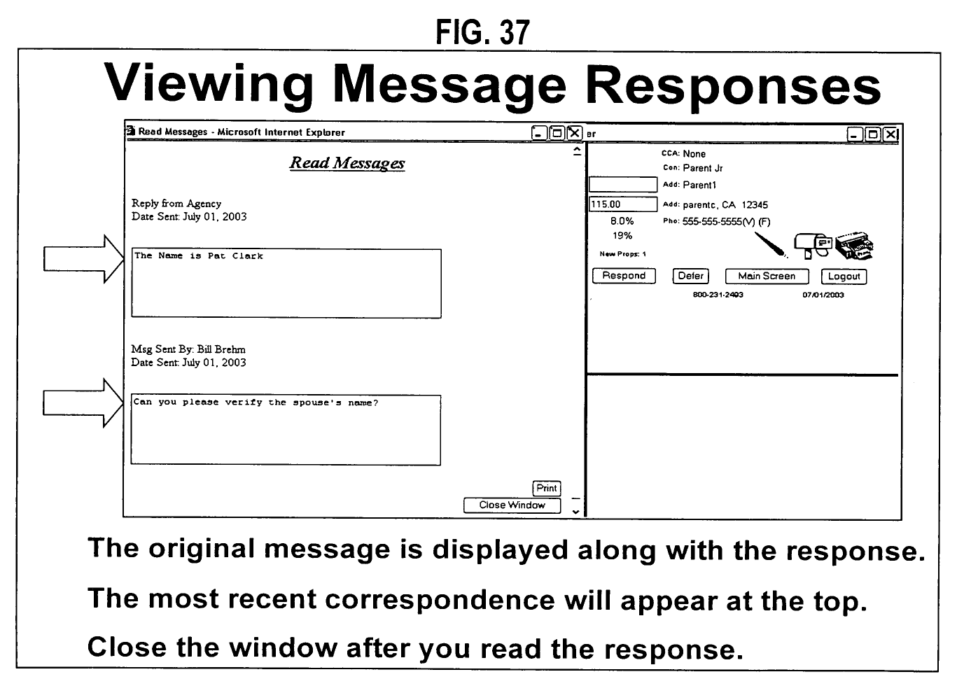

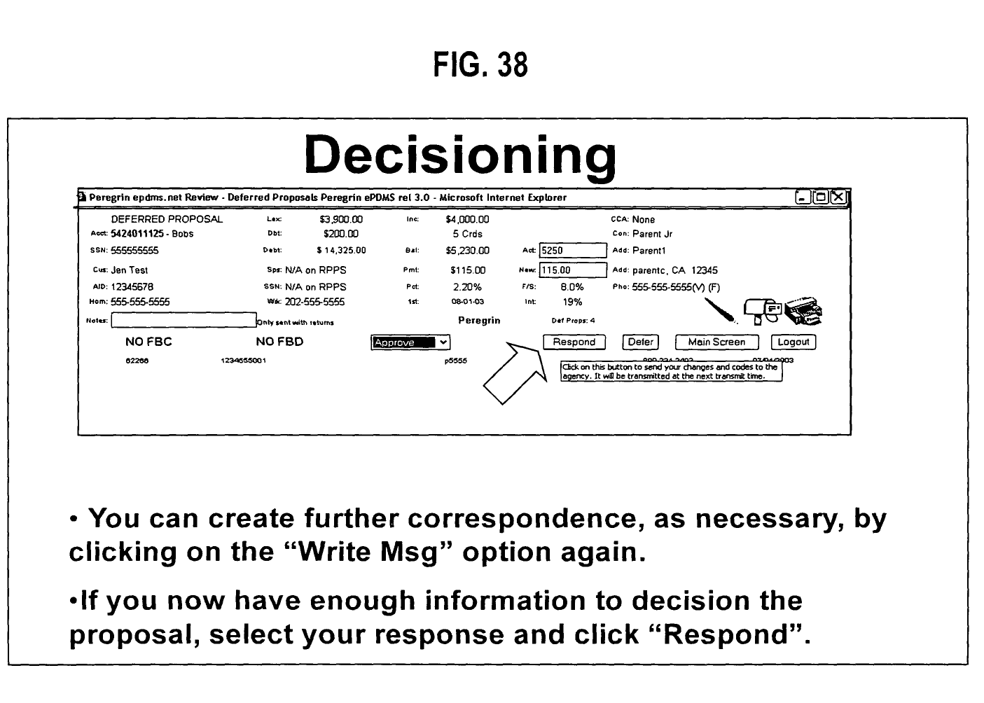

The User can access itemized response by selecting ‘Mailbox’ on the Transaction Screen as illustrated in FIG. 34. If messages are waiting in queue, select ‘Go To’ in order to view the messages attached to a transaction as illustrated in FIG. 35. When an inbound or outbound message is attached to a proposal, a mailbox icon will appear on the Proposal Processing screen as illustrated in FIG. 36. Click on the mailbox icon to review messages associated with that proposal. The original message is displayed along with the response. The most recent correspondence will appear at the top as illustrated in FIG. 37. The User closes the window after reading the message. Additional messages can continue to be sent as needed as illustrated in FIG. 38.

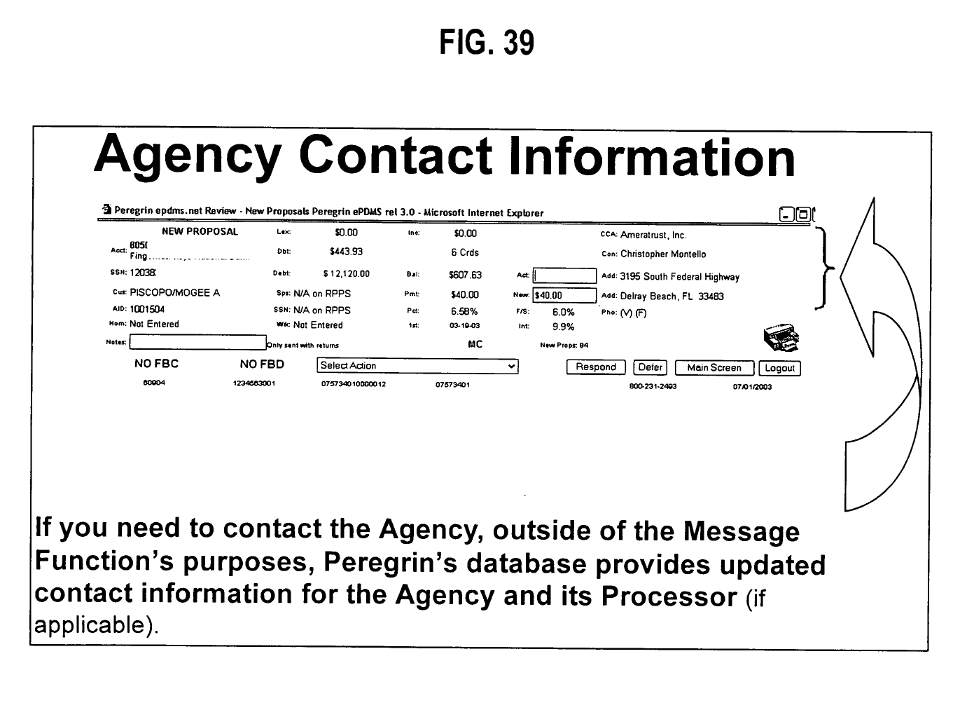

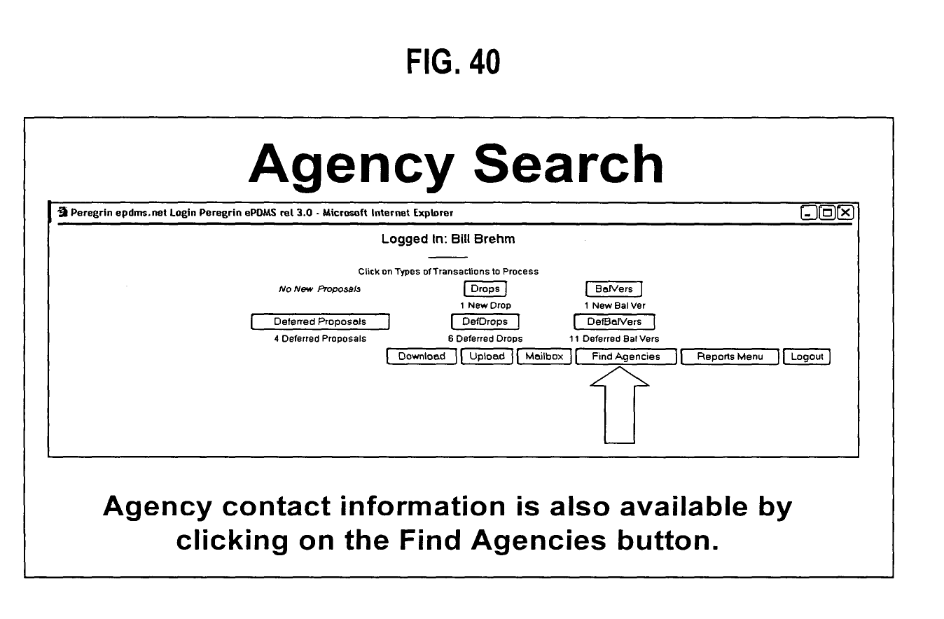

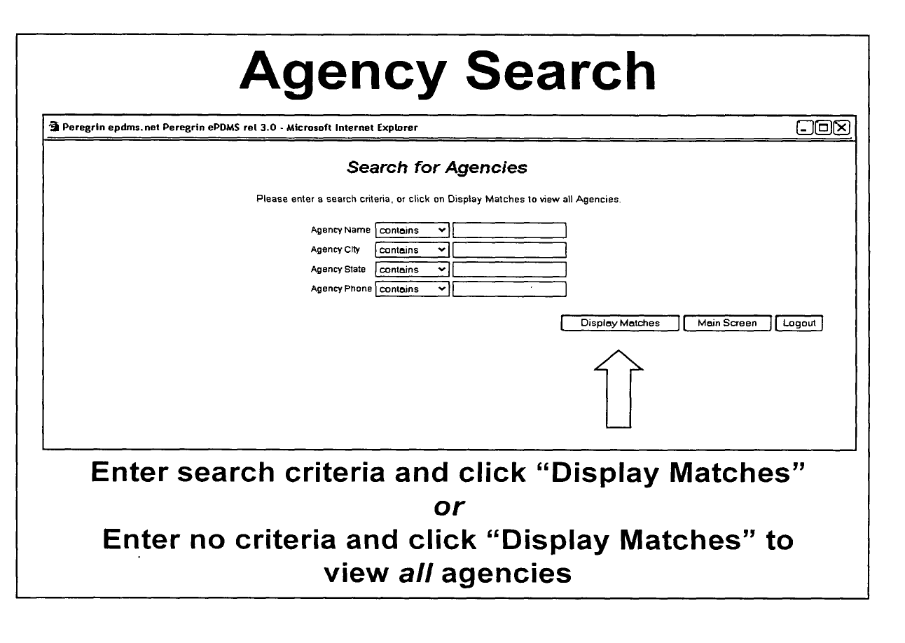

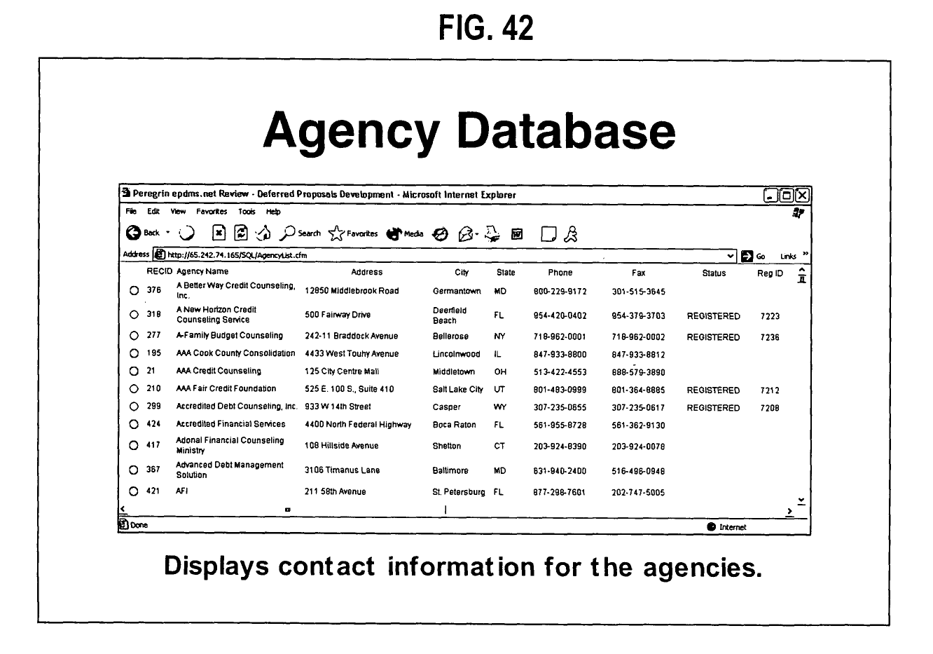

At times it may be appropriate for a creditor User to talk directly with an originating agency therefore the originating agency contact information is provided on the Proposal Processing screen as illustrated in FIG. 39. Additionally, a User may lookup an agency within the database by clicking the ‘Find Agencies’ button from the Transactions Screen (Main Menu) 64 as illustrated in FIG. 40. The Search for Agencies screen will appear where the User can search by Agency Name, Agency City, Agency State, or Agency Phone and then click the ‘Display Matches’ button as illustrated in FIG. 41. Clicking the ‘Display Matches button executes a SQL query command of the database and the results appear on the next screen as illustrated in FIG. 42. Using the mouse pointer 46 a User may select agency results that were returned to view more detailed information about that agency.

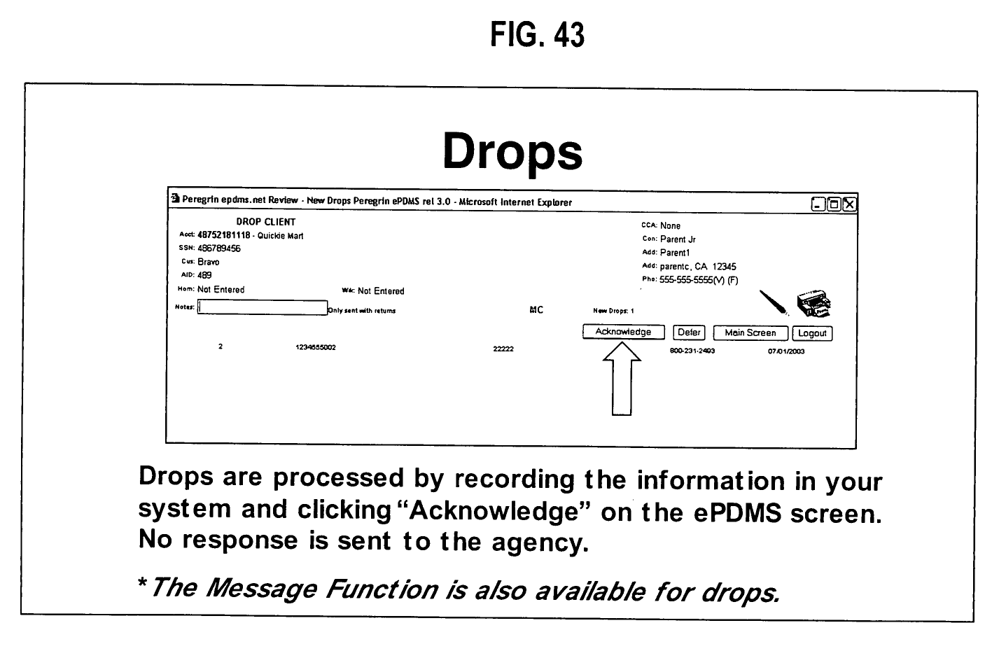

Sometimes it is appropriate to ‘Drop’ a consumer from a debt management plan for various reasons, ‘Drops’ are processed in a similar manner to proposals. The Transaction Screen (Main Menu) 64 FIG. 13 will indicate if new drops are available for the creditor. After selecting the ‘Drops’ button the next window to appear will be the Drops screen, the screen is for informational purposes to the Creditor User. The Creditor User will annotate the consumer drop within their internal system and then click the ‘Acknowledge’ button on the screen as illustrated in FIG. 43. No reply is sent back to the originating agency unless the Message Function is used.

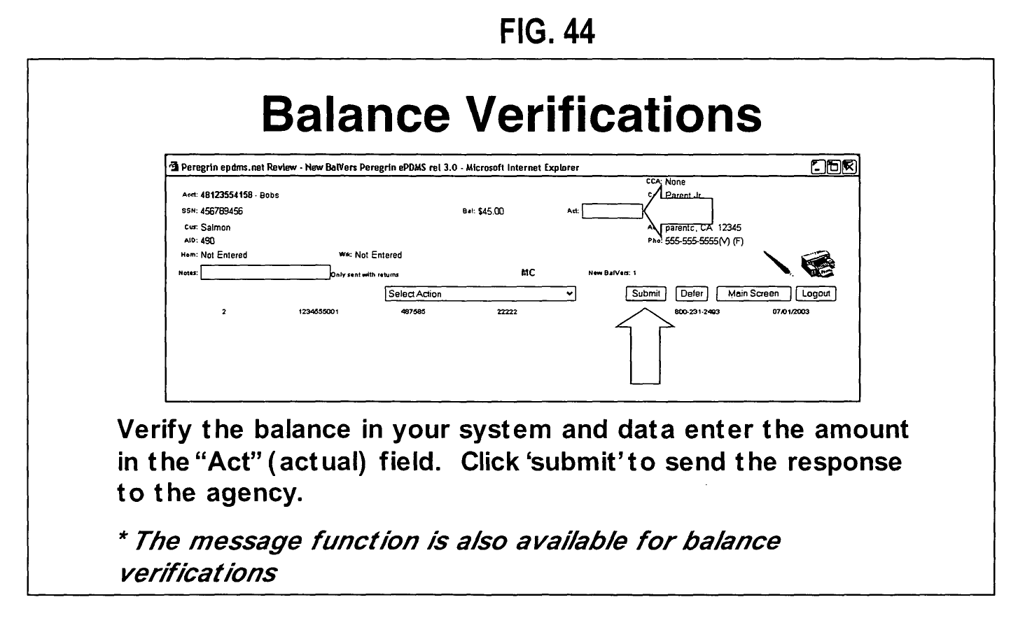

Balance Verifications are also processed similar to a proposal. The Transaction Screen (Main Menu) 64 FIG. 13 will indicate if new Balance Verifications are available for the creditor. After selecting the ‘BalVers’ button the Balance Verifications screen will appear where the Creditor User will data enter the current account balance into the ‘Act’ (actually account balance) field provided and then click the ‘Submit’ button as illustrated in FIG. 44. This account balance information will be transmitted back to the requesting originating agency. The message function is also available for balance verifications.

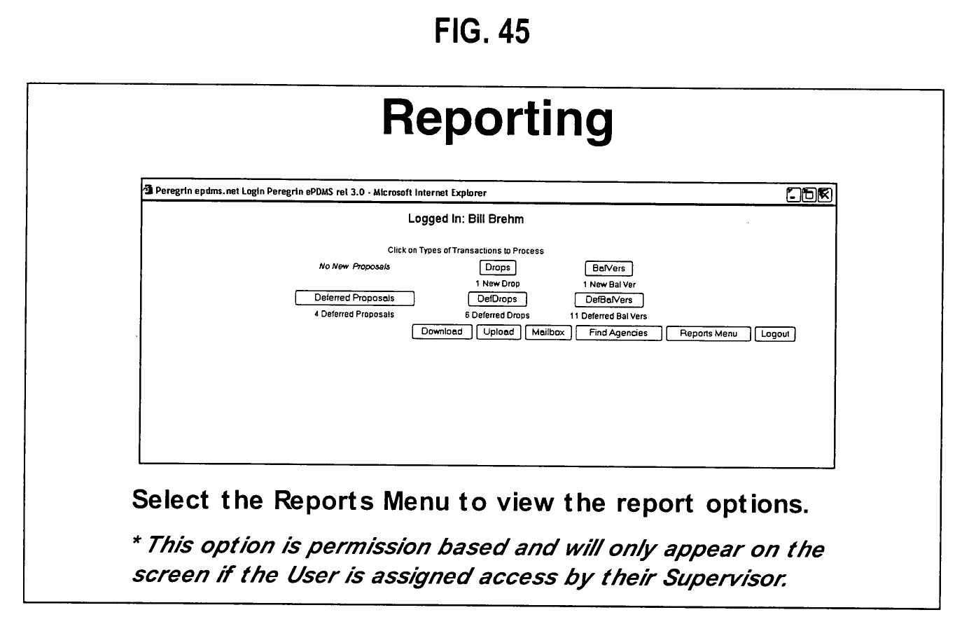

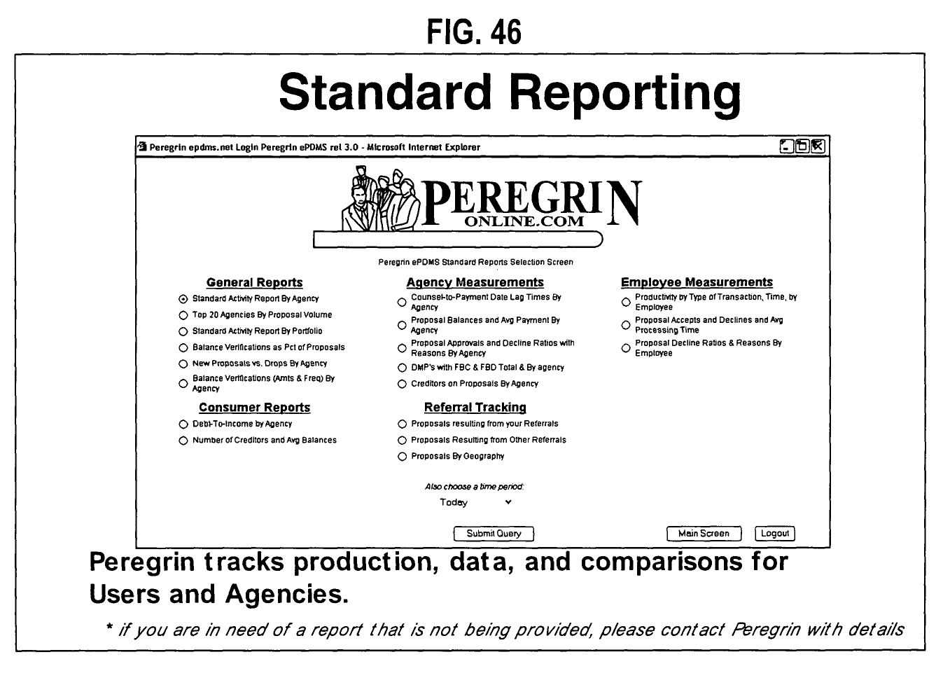

A variety of reports are available to Users that can be accessed by the Transaction Screen (Main Menu) 64 FIG. 13. This option is permission based and will appear on the screen if the User is assigned access by their Supervisor and authenticated in the initial login procedure. As illustrated in FIG. 45 the User accesses the Reports Menu by clicking the ‘Reports Menu’ button. The Reports Menu page will appear next FIG. 46 listing the reports available by category:

General Reports

Consumer Reports

Agency Measurements

Referral Tracking

Employee Measurements

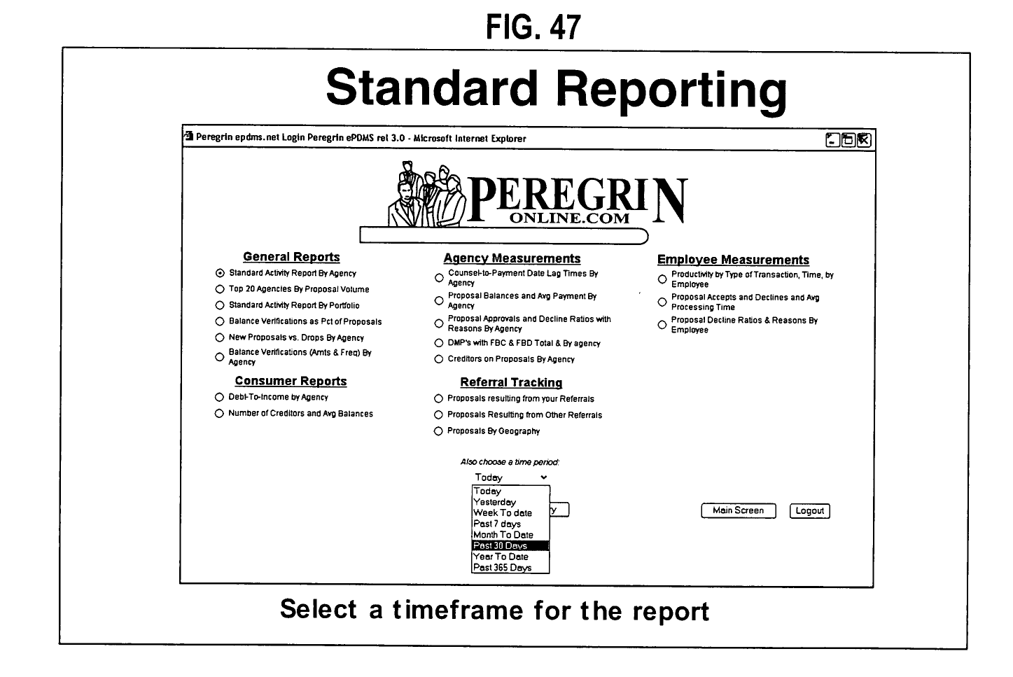

Each report is supported by a unique SQL query with one supported variable consisting of the time period. A User can define the following time periods as illustrated in FIG. 47:

Today

Yesterday

Week to date

Past 7 days

Month to date

Past 30 days

Year to date

Past 365 days

Custom time period

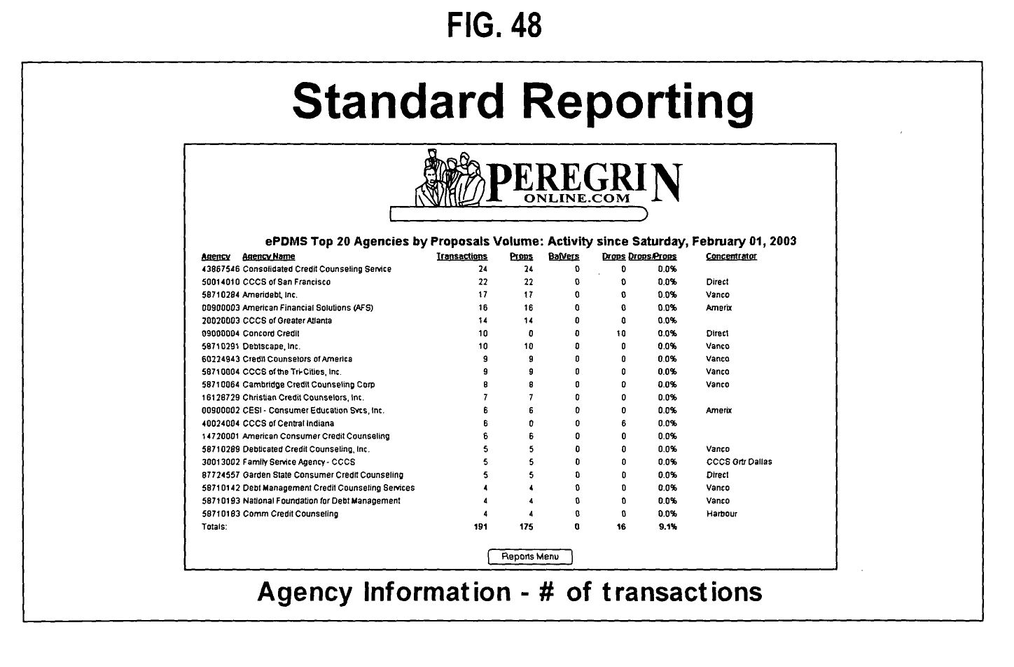

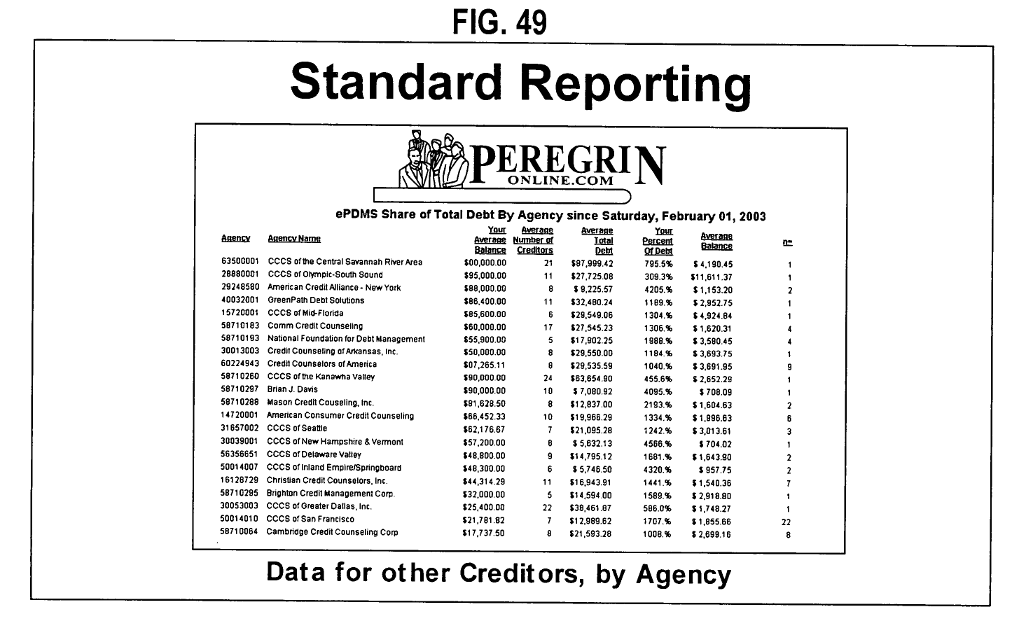

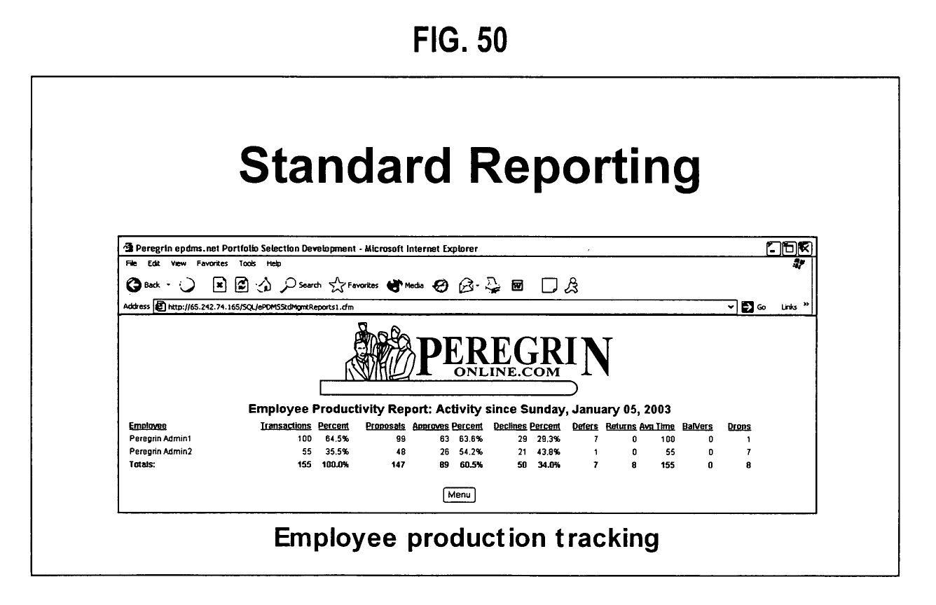

Each report is in a standard report format as illustrated in FIGS. 48-50.

Returning now to the Intermediary Computer 12 system, in this Client/Server embodiment, the Request Originating Computer 2 and the Creditor Computer 38 are considered the clients. Clients access the System 1 through the Applications Server 28. The Applications Server 28 makes connections to the Database Server 26 to access data and return the results to the clients. This allows the Application Server 28 to organize all client connections to the Database Server for optimum connection pooling.

The System 1 is designed to transfer or exchange information between the Request Originating Computer 2, and the Creditor Computer 38 with the System 1 directing the flow of exchange and then warehousing the data in a SQL database on the Database Server 26. Clients use a web server application written in Cold Fusion for easy access to the SQL database using the Internet to establish communications to the Applications Server 28. This is illustrated in FIGS. 11-65. ODBC serves as the application programming interface (API) that transform SQL Server instructions and data into system calls that communicate with the underlying network protocol layer. TCP/IP is selected at the network protocol layer. The Local Area Network 17 is Ethernet.

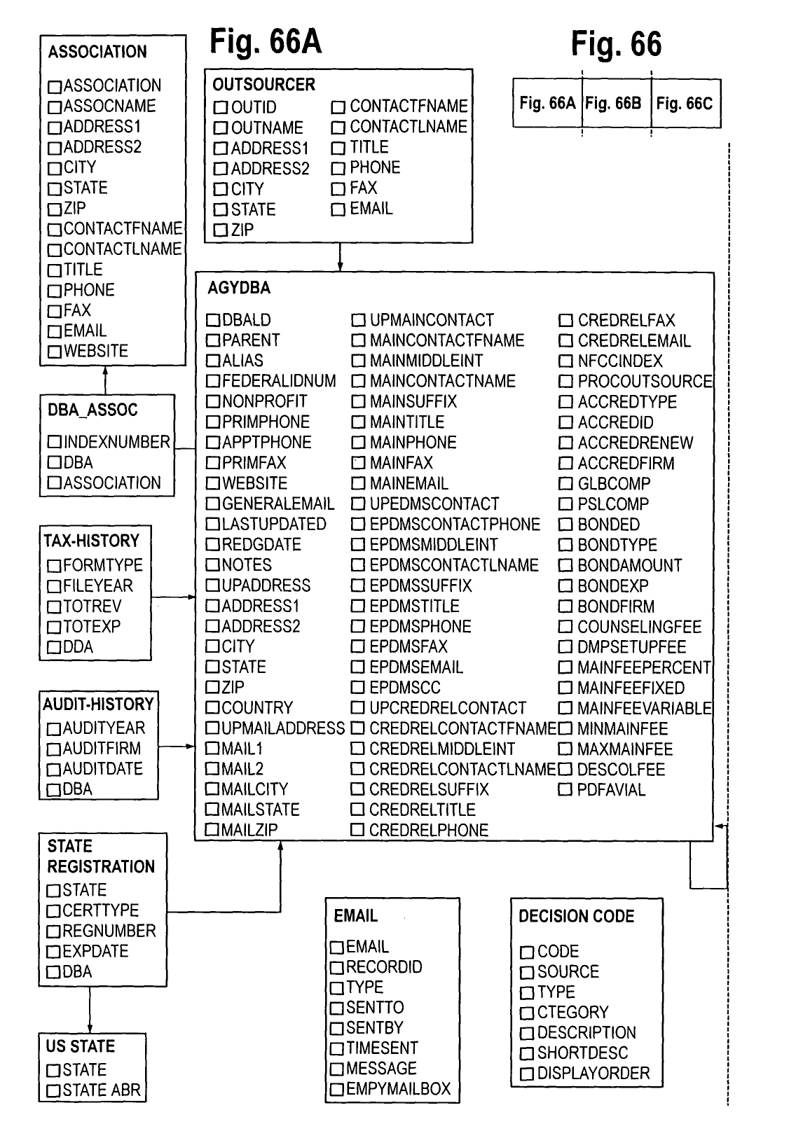

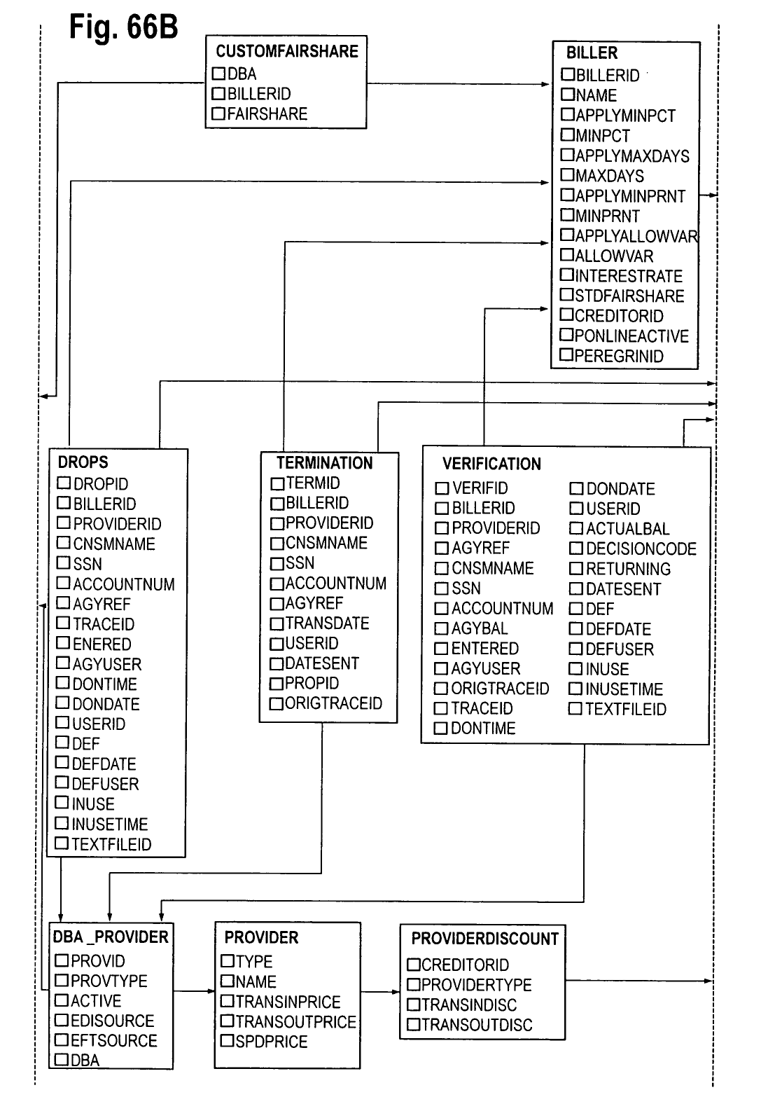

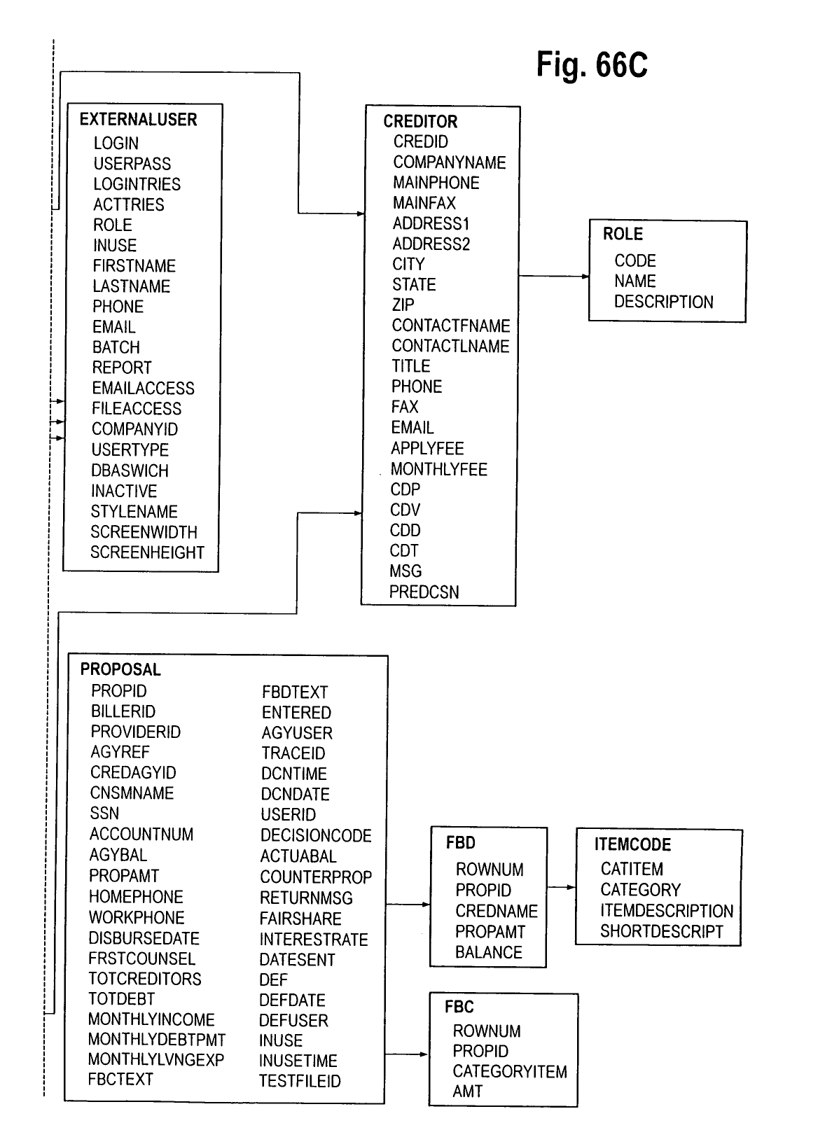

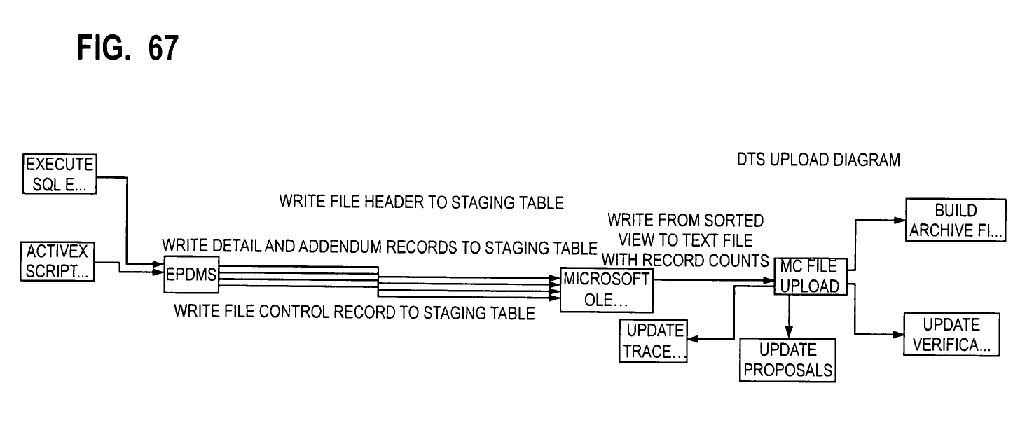

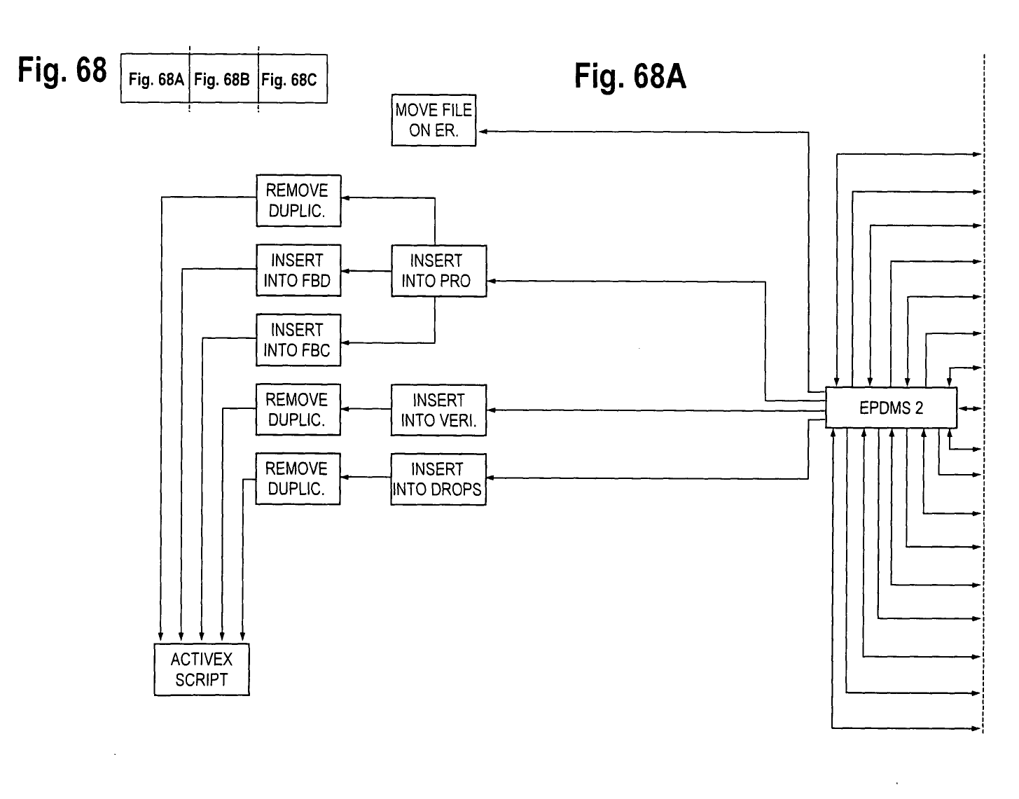

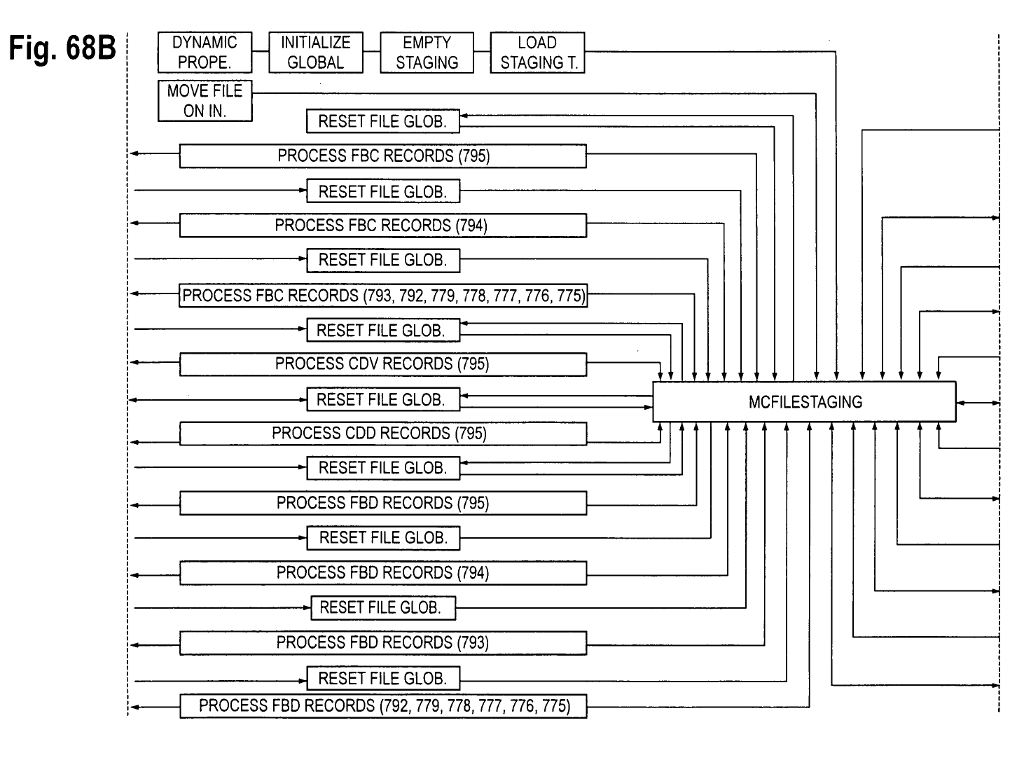

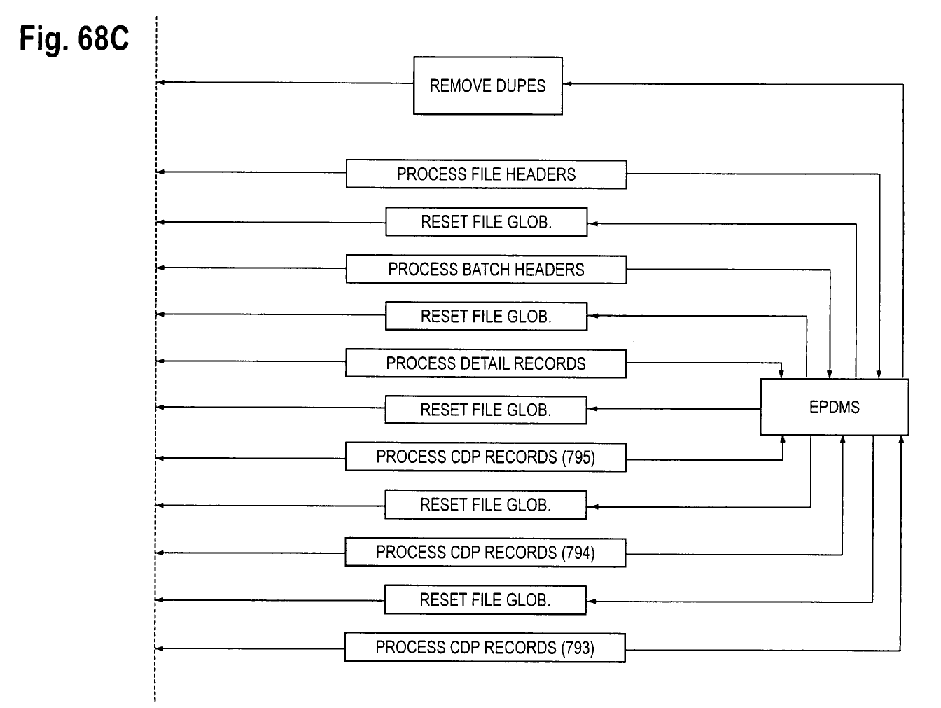

The SQL database uses tables FIG. 66 to organize and store data, system stored procedures to accept input parameters, use local variables, and return data. System stored procedures can return data by using output parameters, return codes, result sets from SELECT statements, or global cursors. Defaults are used where no value is explicitly entered; constraints are used for identifying valid values and for enforcing data integrity within the database tables and between related tables.

The SQL database is designed to accept data files/requests from multiple sources, MasterCard RPPS and Visa EPay are two such sources. These sources have scheduled times when data files are downloaded to The System 1. Sequel Server Scheduler is set to execute the Sequel Download Manager program once each hour. Upon execution the Sequel Download Manager program queries the download directory for any new files from MasterCard RPPS or Visa EPay. If a new file is found the Sequel Download Manager program executes the Sequel Download program, which parses the new file into the proper database tables and sets system flags to indicate that new records are available for processing by either Request Originating Computer 2 or Creditor Computer 38. Additionally, a copy of file is created in the Processed directory. The Sequel Download program parses the file as follows:

Transactions are separated correctly by type—

Proposals

Balance Verification

Drops

Transactions are separated by Biller/Creditors

Transactions are separated by Portfolio

Transactions are separated by Request Originating Computer (Agency) 2

Additionally, Sequel Server Scheduler is set to execute the Sequel Upload program at alternating times. The Sequel Upload program runs a system-stored procedure that looks for newly processed records. Upon finding newly processed records the program determines the input source (MasterCard RPPS or Visa EPay) and creates an upload file in the appropriate format and specifications for each source. Once assembled the newly created upload file is placed in the upload directory with appropriately assigned file names relative to the communications requirements of each source. The Sequel upload program updates each record of the newly created file with the date/time the record was uploaded. A duplicate copy of the file is stored in the Processed directory.

Additional input sources would be the Clients from either the Request Originating Computer 2 or the Creditor Computer 38 who can submit data at any time and therefore the Sequel Server Scheduler is not used with these sources. The Cold Fusion web application is used to pass variables to the database where system stored procedures executes the steps to create new records and queries are used to update existing records.

Depending upon the transaction type or function desired by the clients the Cold Fusion web application passes custom queries to the Sequel database to perform the Sequel database operation. Examples would be:

Creditor Computer 38, after a successful logon by a User a query is run automatically to count available transactions in the creditor work queue. The transactions are sorted by transaction type.

Request Originating Computer 2, when a User desires to check for ‘Pending’ proposals the Cold Fusion web application submits a query to the SQL database by clicking the ‘Pending’ button and the results are returned and displayed in Cold Fusion.

While the above description contains many specificity's, these should not be construed as limitations on the scope of the invention, but rather as an exemplification of the invention and one embodiment thereof. Many other variations are possible. Thus, the foregoing is illustrative of the broad scope of the invention, which more particularly should be determined by the patent claims and their equivalents, rather than by the principal embodiment and other examples described above.

We claim:

1. A method for Internet-based intermediary computing to handle debt management plan requests, the method including the steps of:
receiving respective debt management plan requests at an intermediary computer, by Internet communication, from each of a plurality of request-originating computers;
processing said respective debt management plan requests with said intermediary computer to produce respective, formatted and at least partially validated debt management plan requests;
using said respective, formatted and at least partially validated debt management plan requests in enabling a respective debt management plan decision at one of said intermediary computer and a creditor computer; and
electronically communicating a signal of said decision to the request-originating computer.

2. The method of claim 1, further including the steps of:
programming the intermediary computer to present an electronic form at the request originating computers, the electronic form structured to induce inputting of respective debt management plan request information;
entering the respective debt management plan request information, responsive to the presented electronic form, at input devices operably connected respectively to the request-originating computers, to recognizably structure the respective debt management plan requests for the intermediary computer; and
communicating the respective debt management plan requests from the request-originating computers to the intermediary computer to carry out the receiving.

3. The method of claim 1, further including the steps of:
programming the intermediary computer to receive a batch file communication of the respective debt management plan requests;
structuring the respective debt management plan requests at the request-originating computers to produce a batch file communication recognizably structured for the intermediary computer; and
communicating the respective debt management plan requests, by said file communication, from the request-originating computers to the intermediary computer to carry out the receiving.

4. The method of claim 1, wherein the enabling includes:
forming an on-line presentation of said debt management plan decision requests;
conveying the on-line presentation from the intermediary computer to one of the request-originating computers to induce the respective debt management plan decision.

5. The method of claim 2, wherein the enabling includes:
forming an on-line presentation of said debt management plan decision requests;
conveying the on-line presentation from the intermediary computer to one of the request-originating computers to induce the respective debt management plan decision.

6. The method of claim 3, wherein the enabling includes:
forming an on-line presentation of said debt management plan decision requests;
conveying the on-line presentation from the intermediary computer to one of the request-originating computers to induce the respective debt management plan decision.

7. The method of claim 1, wherein the enabling includes:
applying at least one rule in automatically producing one of the respective debt management plan request decision at the intermediary computer; and
signaling the creditor computer of automatically produced decision.

8. The method of claim 7, wherein the step of applying at least one rule is carried out with a rule for automatically producing a rejection as the debt management plan request decision.

9. The method of claim 7, wherein the step of applying at least one rule is carried out with a rule for automatically producing an acceptance as the debt management plan request decision.

10. The method of claim 8, wherein the step of applying at least one rule is carried out with a rule for automatically producing an acceptance as the one of the debt management plan request decisions.

11. The method of claim 2, wherein the enabling includes:
applying at least one rule in automatically producing one of the respective debt management plan request decision at the intermediary computer; and
signaling the creditor computer of automatically produced decision.

12. The method of claim 11, wherein the step of applying at least one rule is carried out with a rule for automatically producing a rejection as the debt management plan request decision.

13. The method of claim 1 1, wherein the step of applying at least one rule is carried out with a rule for automatically producing an acceptance as the debt management plan request decision.

14. The method of claim 13, wherein the step of applying at least one rule is carried out with a rule for automatically producing an acceptance as the one of the debt management plan request decisions.

15. The method of claim 3, wherein the enabling includes:
applying at least one rule in automatically producing one of the respective debt management plan request decision at the intermediary computer; and
signaling the creditor computer of automatically produced decision.

16. The method of claim 15, wherein the step of applying at least one rule is carried out with a rule for automatically producing a rejection as the debt management plan request decision.

17. The method of claim 15, wherein the step of applying at least one rule is carried out with a rule for automatically producing an acceptance as the debt management plan request decision.

18. The method of claim 17, wherein the step of applying at least one rule is carried out with a rule for automatically producing an acceptance as the one of the debt management plan request decisions.

19. The method of claim 1, further including the step of providing a status report at said intermediary computer, the status report corresponding to at least one of said debt management requests.

20. The method of claim 19, further including the step of providing a status report at said intermediary computer, the status report corresponding to an aggregate of said debt management requests in a period of time.

21. The method of any one of claims 1-20, further including the step of providing a web site to facilitate at least one of said steps.

22. The method of claim 21, wherein said processing includes testing, with said intermediary computer, for a plurality of criteria including a known request originating computer, a known user, a known creditor, a known account number, and a known mask or format.
